(19) United States
(12) Patent Application Publication
(10) Pub. No.: US 2016/0366481 A1
(43) Pub. Date: Dec. 15, 2016

(54) METHOD AND APPARATUS FOR SERVICE ORIENTED INPUT AND OUTPUT

(71) Applicant: Samsung Electronics Co., Ltd., Suwon-si (KR)

(72) Inventors: Yun-Jae LIM, Seoul (KR); Ji-Eun KIM, Suwon-si (KR); Hyun-Suk MIN, Suwon-si (KR); Ju-Seok YOON, Suwon-si (KR); Dong-Un LEE, Yongin-si (KR); Sang-Sun CHOI, Seoul (KR); Dong-Woo LEE, Suwon-si (KR); Byeong-Bae CHOI, Yongin-si (KR); Jong-Youb RYU, Suwon-si (KR); Yong-Hyun LIM, Suwon-si (KR); Jae-Eun KANG, Suwon-si (KR); Chang-Han KIM, Suwon-si (KR)

(21) Appl. No.: 15/168,885

(22) Filed: May 31, 2016

(30) Foreign Application Priority Data
Jun. 12, 2015 (KR) 10-2015-0083504
Dec. 9, 2015 (KR) 10-2015-0174829

(51) Int. Cl. H04N 21/478; H04N 5/44; H04N 21/422

(52) U.S. Cl. CPC H04N 21/478; H04N 21/4221; H04N 5/4403; H04N 2005/4412

(57) ABSTRACT

The present disclosure relates to technologies for sensor networks, a machine-to-machine (M2M) interface, machine-type communication (MTC), and an Internet of things (IoT). The present disclosure may be used in intelligent services (e.g., a smart home, a smart building, a smart city, a smart car, a connected car, health-care, digital education, a retail business, security and safety-related services, etc.). A service-oriented input and output method and apparatus for a smart control system are provided. The method includes receiving a hot key input from a remote controller, transmitting a command corresponding to the hot key input to a device corresponding to the command, receiving a processing result according to the command from the device, when a display is inactivated upon reception of the processing result, activating the display and outputting a message according to the processing result through the display, and inactivating the display after the output of the message is ended.

### CROSS-REFERENCE TO RELATED APPLICATION(S)

This application claims the benefit under 35 U.S.C. §119(a) of a Korean patent application filed on Jun. 12, 2015 in the Korean Intellectual Property Office and assigned Serial No. 10-2015-0083504, and of a Korean patent application filed on Dec. 9, 2015 in the Korean Intellectual Property Office and assigned Serial No. 10-2015-0174829, the entire disclosure of each of which is hereby incorporated by reference.

### TECHNICAL FIELD

The present disclosure relates to methods and apparatuses for providing service-oriented inputs and outputs.

### BACKGROUND

The Internet is evolving from a human-centered connection network, by which humans create and consume information, to an Internet of things (IoT) network, by which information is communicated and processed between things or other distributed components. The Internet of everything (IoE) technology may be an example of a combination of the big data processing technology and the IoT technology through, e.g., a connection with a cloud server.

To implement the IoT, technology elements, such as a sensing technology, wired/wireless communication and network infrastructure, service interface technology, and a security technology are required. Recently, there is ongoing research for inter-object connection technologies, such as the sensor network, a machine-to-machine (M2M) interface, or a machine-type communication (MTC).

In the IoT environment, intelligent Internet Technology (IT) services may be offered that collect and analyze the data generated by the things connected with one another to provide user convenience. The IoT may have various applications, such as a smart home, a smart building, a smart city, a smart car or a connected car, a smart grid, the health-care industry, or the smart appliance industry, or state-of-the-art medical services, through conversion or integration of existing IT technologies and various industries.

The advent of IoT services introduces techniques for implementing a service to tie various devices with a single network. The IoT is the technology allowing seamless connection for all network-based devices and is required for diversified IT service applications. Various techniques are being researched to implement such IoT services. A representative example is the control of smart homes or smart hotels.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for communicating information in a remote control system.

Another aspect of the present disclosure is to provide a method and apparatus for providing service-oriented inputs and outputs in a network system for remote control.

Another aspect of the present disclosure is to provide a method and apparatus for performing device control through a gateway in a smart hotel control system.

Another aspect of the present disclosure is to provide a method and apparatus for processing a room service request through a gateway in a smart hotel control system.

Another aspect of the present disclosure is to provide a method and apparatus for displaying a result of processing a service request through a display of a gateway in a network system.

Another aspect of the present disclosure is to provide a method and apparatus for displaying an adaptive control menu through a remote controller in a smart hotel control system.

Another aspect of the present disclosure is to provide a method and apparatus for displaying an adaptive control menu according to orientation information of a remote controller.

In accordance with an aspect of the present disclosure, a method for a service-oriented input and output is provided. The method includes determining orientation information regarding a remote controller in response to a first user input detected by the remote controller, selecting a device based on location information regarding devices included in a previously stored controlled target list and the determined orientation information, outputting a control menu including at least one control item for the selected device, detecting a second user input corresponding to the output control menu, and transmitting a control command indicating a control item corresponding to the second user input to the selected device.

In accordance with another aspect of the present disclosure, a method for a service-oriented input and output is provided. The method includes receiving a first user input signal corresponding to a first user input detected by a remote controller and including orientation information regarding the remote controller, selecting a device based on location information regarding devices included in a previously stored controlled target list and the orientation information, transmitting information regarding a control menu including at least one control item for the selected device to a television (TV) display, receiving a second user input signal corresponding to a second user input detected by the remote controller while the control menu is displayed by the TV display, and transmitting a control command indicating a control item corresponding to the second user input to the selected device.

In accordance with another aspect of the present disclosure, an apparatus for providing a service-oriented input and output is provided. The apparatus includes an input unit configured to detect a user input, an output unit including a display, a controller configured to determine orientation information in response to a first user input detected by the input unit, select a device based on location information regarding devices included in a previously stored controlled target list and the determined orientation information, generate a control menu including at least one control item for the selected device and output the control menu through the display, and generate a control command indicating a control item corresponding to a second user input when the second user input is detected by the input unit while the control menu is displayed, and a communication unit configured to transmit the control command to the selected device.

In accordance with another aspect of the present disclosure, an apparatus for providing a service-oriented input and output is provided. The apparatus includes a first communication unit configured to communicate with a remote controller, a second communication unit configured to communicate with a plurality of devices, and a controller configured to select a device based on location information regarding devices included in a previously stored controlled target list and orientation information regarding the connection request when a first user input signal corresponding to a first user input detected by the remote controller and including the orientation information is received by the first communication unit, output information regarding a control menu including at least one control item for the selected device through a TV display, and transmit a control command indicating a control item corresponding to a second user input detected by the remote controller to the selected device through the second communication unit when a second user input signal corresponding to the second user input is received by the first communication unit while the control menu is displayed through the TV display.

In accordance with another aspect of the present disclosure, a method for a service-oriented input and output is provided. The method includes receiving a hot key input from a remote controller, transmitting a command corresponding to the hot key input to a device corresponding to the command, receiving a processing result according to the command from the device, when a display is inactivated upon reception of the processing result, activating the display and outputting a message according to the processing result through the display, and inactivating the display after the output of the message is ended.

In accordance with another aspect of the present disclosure, a method for a service-oriented input and output is provided. The method includes receiving a command corresponding to a hot key input detected by a remote controller, determining whether the command relates to a device control or a service request, determining at least one controlled device when the command relates to the device control and transmitting a control command corresponding to the command to the determined at least one device, receiving a state changed result from the at least one device and outputting the state changed result through a TV display, transmitting a service identifier (ID) corresponding to the command to a hotel server when the command relates to the service request, receiving a processing result of the service request from the hotel server, and outputting the processing result through the TV display.

In accordance with another aspect of the present disclosure, an apparatus for providing a service-oriented input and output is provided. The apparatus includes a first communication unit configured to receive a hot key input from a remote controller, a second communication unit configured to transmit a command corresponding to the hot key input to a device corresponding to the command and receive a processing result according to the command from the device, and a controller configured to activate a TV display when the TV display is inactivated upon reception of the processing result, output a message according to the processing result through the TV display, and inactivate the TV display after the output of the message is ended.

In accordance with another aspect of the present disclosure, an apparatus for providing a service-oriented input and output is provided. The apparatus includes a first communication unit configured to receive a command corresponding to a hot key input detected by a remote controller, a second communication unit configured to communicate with a hotel server, and a controller configured to determine whether the command relates to a device control or a service request, determine at least one controlled device when the command relates to the device control, transmit a control command corresponding to the command to the determined at least one device, receive a state changed result from the at least one device, transmit the state changed result to a TV display, transmit a service ID corresponding to the command to a hotel server through the second communication unit when the command relates to the service request, receive a processing result of the service request from the hotel server through the second communication unit, and transmit the processing result to the TV display.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A and 1B illustrate examples of a smart hotel control system applied according to various embodiments of the present disclosure;

FIG. 2 illustrates an example of remote control through a television (TV) display according to an embodiment of the present disclosure;

FIG. 3 illustrates an input unit of a remote controller including hot keys according to an embodiment of the present disclosure;

FIG. 4A illustrates a functional configuration of a smart hotel control system according to an embodiment of the present disclosure;

FIG. 4B illustrates a functional configuration of a remote controller according to an embodiment of the present disclosure;

FIG. 5A is a flowchart illustrating an operation of determining a hot key code according to an embodiment of the present disclosure;

FIG. 5B is a flowchart illustrating an operation of processing a command according to an embodiment of the present disclosure;

FIG. 6 is a flowchart illustrating an operation of processing a hot key input according to an embodiment of the present disclosure;

FIG. 7 is a flowchart illustrating an operation of displaying a result of inputting or processing a hot key according to an embodiment of the present disclosure;

FIG. 8 is a signal flowchart illustrating an operation of processing a service request or device control according to an embodiment of the present disclosure;

FIG. 9 illustrates a functional configuration of a gateway according to an embodiment of the present disclosure;

FIG. 10 illustrates a procedure of running a device control command in a gateway according to an embodiment of the present disclosure;

FIG. 11 illustrates a procedure of receiving a result of varying a device state in a gateway according to an embodiment of the present disclosure;

FIG. 12 is a view illustrating a procedure of processing device control according to an embodiment of the present disclosure;

FIG. 13 is a view illustrating a procedure of processing a service request according to an embodiment of the present disclosure;

FIG. 14 illustrates a screen of a TV display to indicate a change in the state of a service request according to an embodiment of the present disclosure;

FIG. 15 illustrates a screen of a TV display to indicate a change in temperature according to an embodiment of the present disclosure;

FIGS. 16A and 16B illustrate screens of a TV display outputting a processing result while a TV native function remains activated according to various embodiments of the present disclosure;

FIG. 17 illustrates a scheme of processing a hot key input according to an embodiment of the present disclosure;

FIG. 18 is a flowchart illustrating an operation of controlling illumination according to an embodiment of the present disclosure;

FIG. 19 illustrates a hot key input by a mobile terminal operating as a remote controller according to an embodiment of the present disclosure;

FIG. 20 illustrates other examples of a remote controller according to an embodiment of the present disclosure;

FIG. 21 is a view illustrating a hot key mapping guide according to an embodiment of the present disclosure;

FIG. 22 is an overall flowchart illustrating an example of providing a hot key mapping guide according to an embodiment of the present disclosure;

FIG. 23 illustrates an example of providing a hot key mapping guide according to a direction indicated by a remote controller according to an embodiment of the present disclosure;

FIGS. 24A to 24D are views illustrating an operational procedure of providing a hot key mapping guide according to a direction indicated by a remote controller according to various embodiments of the present disclosure;

FIG. 25 is a flowchart illustrating an operation of providing an adaptive hot key mapping guide according to an embodiment of the present disclosure;

FIG. 26 is a signal flowchart illustrating an example of providing an adaptive hot key mapping guide by a remote controller according to an embodiment of the present disclosure;

FIG. 27 is a signal flowchart illustrating an example of providing an adaptive hot key mapping guide when a plurality of devices are oriented in the same direction according to an embodiment of the present disclosure;

FIG. 28 is a flowchart illustrating an operation by a remote controller to provide a hot key mapping guide according to an embodiment of the present disclosure;

FIG. 29 is a flowchart illustrating an operation by a gateway to provide a hot key mapping guide according to an embodiment of the present disclosure;

FIG. 30 is a signal flowchart illustrating an example of controlling a device corresponding to orientation information by a gateway according to an embodiment of the present disclosure;

FIG. 31 is a flowchart illustrating an operation by a gateway displaying a hot key mapping guide according to an embodiment of the present disclosure;

FIGS. 32A and 32B illustrate input units of hot key-dedicated remote controllers according to various embodiments of the present disclosure;

FIGS. 33A and 33B are views illustrating examples of using a hot key-dedicated remote controller according to various embodiments of the present disclosure;

FIG. 34 is a flowchart illustrating an operation of providing a hot key mapping guide considering a room situation according to an embodiment of the present disclosure;

FIGS. 35A to 35C are views illustrating examples of providing an adaptive hot key guide according to time according to various embodiments of the present disclosure;

FIGS. 36A and 36B are views illustrating examples of providing a hot key mapping guide reflecting a user's state according to various embodiments of the present disclosure;

FIG. 37 is a view illustrating an example of providing an adaptive hot key mapping guide according to a room mode according to an embodiment of the present disclosure;

FIG. 38 is a view illustrating a hot key mapping guide configured according to a hot key use history according to an embodiment of the present disclosure;

FIG. 39 illustrates an example of displaying a hot key mapping guide using a room image according to an embodiment of the present disclosure;

FIG. 40 illustrates an input unit of a remote controller including hot keys corresponding to controlled devices according to an embodiment of the present disclosure;

FIG. 41 is a view illustrating a control operation by a curtain using a hot key of a remote controller according to an embodiment of the present disclosure;

FIG. 42 is a view illustrating a control operation by a thermostat using a hot key of a remote controller according to an embodiment of the present disclosure; and

FIG. 43 is a view illustrating a device control and user state input operation using a voice command according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the various embodiments, a description of technologies that are known in the art and are not directly related to the present disclosure is omitted. This is for further clarifying the gist of the present disclosure without making it unclear.

For the same reasons, some elements may be exaggerated or schematically shown. The size of each element does not necessarily reflect the real size of the element.

Advantages and features of the present disclosure, and methods for achieving the same may be understood through the various embodiments to be described below taken in conjunction with the accompanying drawings. However, the present disclosure is not limited to the various embodiments disclosed herein, and various changes may be made thereto. The various embodiments disclosed herein are provided only to inform one of ordinary skilled in the art of the category of the present disclosure.

It should be appreciated that the blocks in each flowchart and combinations of the flowcharts may be performed by computer program instructions. Since the computer program instructions may be equipped in a processor of a general-use computer, a special-use computer, or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operations are performed over the computer or other programmable data processing devices and operate the computer or other programmable data processing devices may provide operations for executing the functions described in connection with a block(s) in each flowchart.

Further, each block may represent a module, a segment, or a part of a code including one or more executable instructions for executing a specified logical function(s). Further, it should be noted that in some execution examples, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, the term “unit” is not limited as meaning a software or hardware element. A ‘unit’ may be configured in a storage medium that may be addressed or may be configured to reproduce one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. A function provided in an element or a ‘unit’ may be combined with additional elements or may be split into sub elements or sub units. Further, an element or a ‘unit’ may be implemented to reproduce one or more central processing units (CPUs) in a device or a security multimedia card.

Although the description of various embodiments herein mentions various wireless communication techniques, the subject matter of the present disclosure may also be applicable to other communication systems or services having similar technical backgrounds without departing from the scope of the present disclosure, and this may be determined by one of ordinary skill in the art.

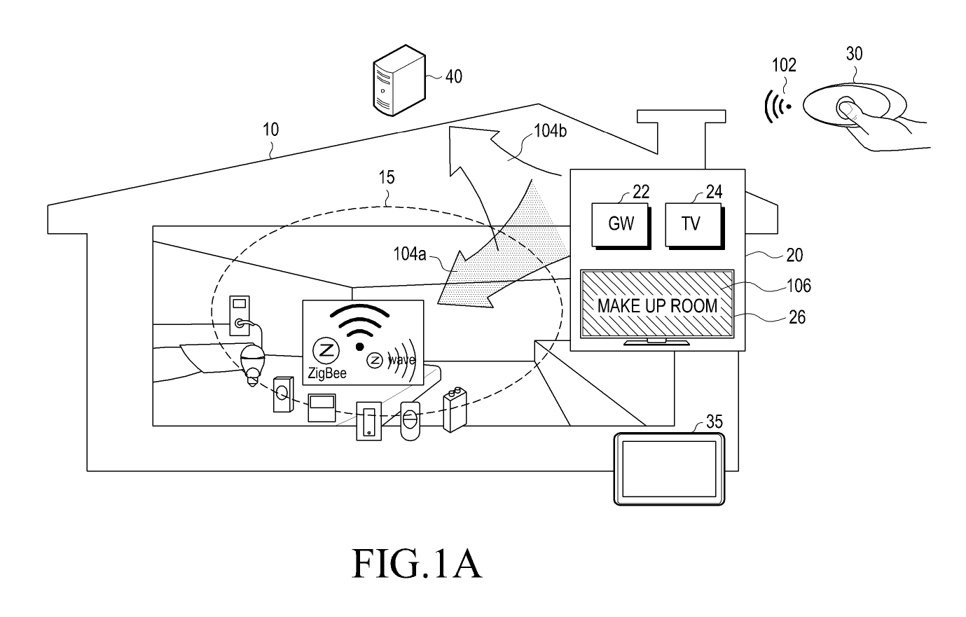

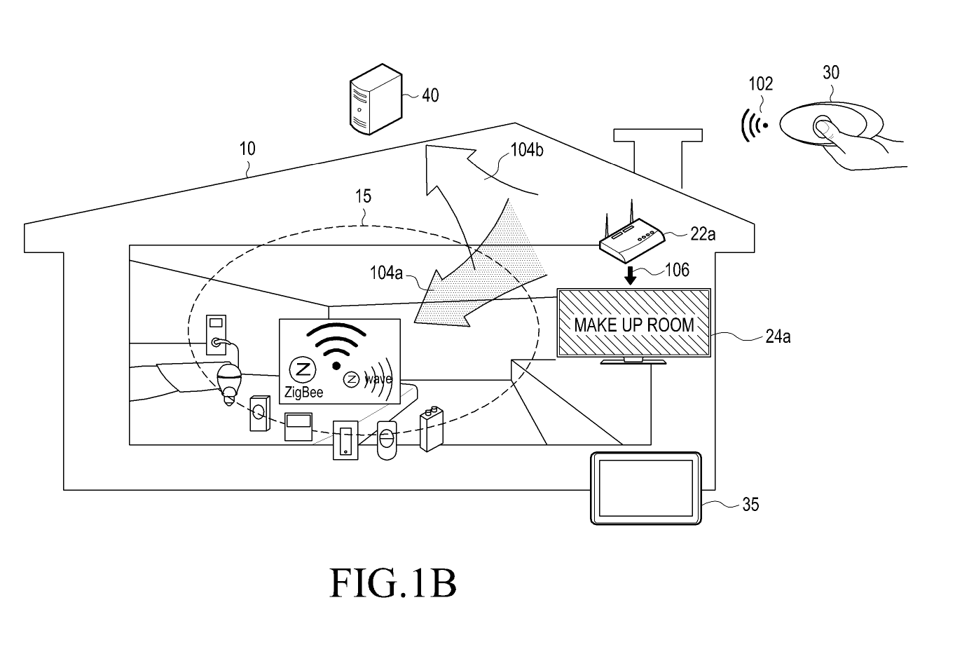

FIG. 1A illustrates an example of a smart hotel control system applied according to an embodiment of the present disclosure.

Referring to FIG. 1A, a hotel 10 may include a smart hotel control system. The smart hotel control system includes a control device 20 having a gateway function, at least one device 15 wiredly or wirelessly connectable with the control device 20, and a remote controller 30. The user may send a command for device control or a service request to the control device 20 using a remote input device such as a mobile terminal 35 equipped with a remote control function or the remote controller 30. The remote controller 30 may be configured as a typical remote controller for controlling native functions of a television (TV). The mobile terminal 35 may be a tablet computer, a smartphone, a wearable device, etc., equipped with an application for performing a TV native function and a management function. As an example, the remote controller 30 or the mobile terminal 35 may communicate with the control device 20 using a wireless communication technology such as infrared ray (IR), Bluetooth (BT), Wi-Fi, ZigBee, Z-wave, etc.

The control device 20 may include a TV function unit (TV Native) 24 and a gateway function unit 22 in charge of management in a room, and a TV display 26. The TV function unit 24 may perform typical TV native functions and may communicate with the remote controller 30 to directly control the TV display 26. The gateway function unit 22 transfers a control command, necessary for device control, or a service request to a corresponding object based on communication with the TV function unit 24. The term “device control” means controlling the operation of devices 15 registered in the smart hotel control system. The term “service request” means sending a request for room service of the smart hotel control system to a hotel server 40. In an embodiment, the hotel server 40 includes a management server that may be located outside the room to which the smart hotel control system shown applies. Further, the controlled devices 15 may include at least one of a power device, a lighting device, a thermostat, a curtain device, a door lock, a cleaner, etc.

As an example, the remote controller 30 transmits a signal corresponding to the user's key input to the control device 20 (102). The control device 20 identifies whether the signal from the remote controller 30 is for device control or service request. When the signal is for device control, the control device 20 transmits a corresponding control command to at least one device 15 to be controlled (104a). When the signal is for service request, the control device 20 transmits a service request command to the hotel server 40 managing the hotel rooms of the smart hotel control system (104b). When receiving a processing result responsive to the device control or the service request from the hotel server 40 or the device 15, the control device 20 may output the processing result through the TV display 26 (106). The processing result may include, e.g., a result of running a service, which corresponds to the service request or an operational state for a particular device. As an embodiment, the control device 20 may output the processing result through the display of the mobile terminal 35 such as a tablet.

FIG. 1B illustrates another example of a smart hotel control system applied according to an embodiment of the present disclosure.

Referring to FIG. 1B, the smart hotel control system may include a gateway 22a, a TV device 24a, at least one device 15 wiredly or wirelessly connectable with the gateway 22a, and a remote controller 30 wiredly or wirelessly connectable with the gateway 22a or the TV device 24a. Here, the TV device 24a includes a TV function unit 24 and a TV display 26 as shown in FIG. 1A.

The user may send a command for device control or service request to the gateway 22a or the TV device 24a using a remote input device such as a mobile terminal 35 equipped with a remote control function or the remote controller 30. The remote controller 30 may be configured as a typical remote controller for controlling TV native functions. The gateway 22a may communicate with the remote controller 30 directly or via the TV device 24a performing a typical TV native function and may control the TV display of the TV device 24a. The gateway 22a transfers a control command necessary for device control or service request to a corresponding object based on communication with the remote controller 30.

As an example, the remote controller 30 transmits a signal corresponding to the user's key input to the gateway 22a directly or through the TV device 24a (102). The gateway 22a identifies whether the signal from the remote controller 30 is for device control or service request. When the signal is for device control, the control device 20 transmits a corresponding control command to at least one device 15 to be controlled (104a). When the signal is for service request, the gateway 22a transmits a service request command to the hotel server 40 of the smart hotel control system (104b). When receiving a processing result responsive to the device control or the service request from the hotel server 40 or the device 15, the gateway 22a may output the processing result through the display of the TV device 24a (106). The processing result may include, e.g., a result of running a service, which corresponds to the service request or an operational state for a particular device. As an embodiment, the gateway 22a may output the processing result through the display of the mobile terminal 35 such as a tablet.

As described above, although the example of FIG. 1A, in which the gateway function unit 22 and the TV function unit 24 are provided in a single device 20, and the example of FIG. 1B, in which the gateway 22a and the TV device 24a are implemented in separate objects physically differentiated from each other are described separately, the gateway function unit 22 and the gateway 22a may be configured to operate substantially in the same manner. Accordingly, it should be appreciated herein that the gateway 22 denotes the gateway function unit 22 shown in FIG. 1A or the gateway 22a shown in FIG. 1B. Likewise, it should be appreciated that the TV function unit 24 denotes the TV function unit 24 shown in FIG. 1A or the TV device 24a shown in FIG. 1B.

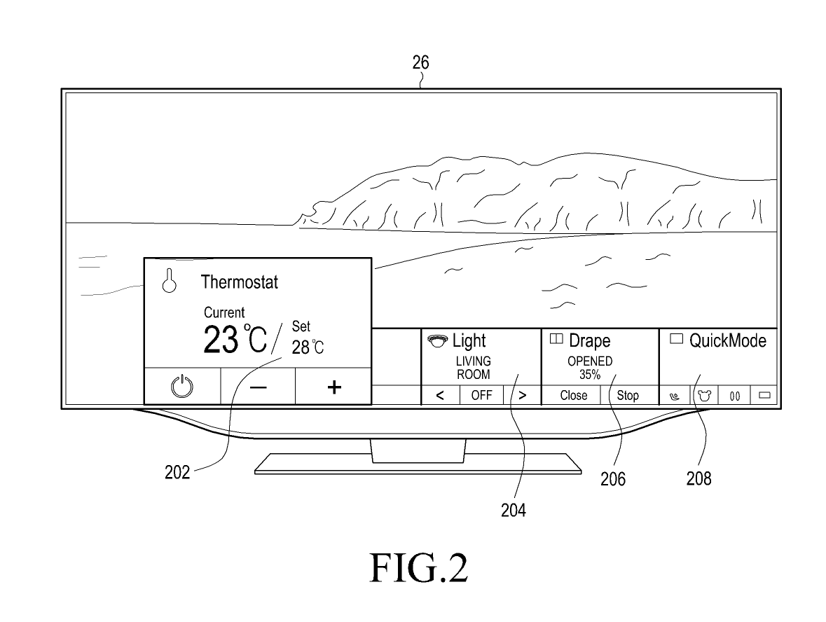

FIG. 2 illustrates an example of remote control through a TV display according to an embodiment of the present disclosure.

Referring to FIG. 2, the TV display 26 may display a control menu for remotely controlling the smart hotel control system, e.g., multiple widgets 202, 204, 206, and 208, in response to a request through the remote controller 30 while displaying a TV image. As an example, the widget 202 is a screen for controlling the temperature in the room and may include a current temperature and a set temperature, an end key, temperature up (+) and temperature down (−) keys, etc. The widget 204 is a screen for controlling illumination per zone in the room and may include a light-on/off state in a particular zone, a shift zone key, and an on/off key. The widget 206 is a screen for opening/closing a curtain (e.g., drape), and the widget 208 includes keys corresponding to a plurality of functions that may be operated in a quick mode.

When the TV function unit 24 is in a standby status or a power-off status so that the TV display 26 remains inactivated (hereinafter, referred to as a display off), the user may activate the TV display 26 using a hot key (hot-key) of the remote controller 30 and may then display widgets for room control of the smart hotel control system using the remote controller 30 and may select one of the widgets to perform desired room control.

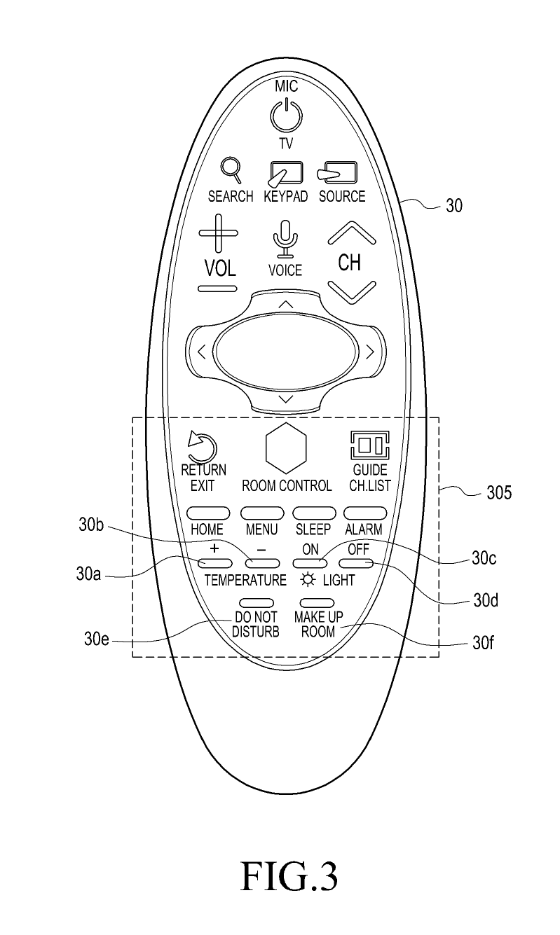

FIG. 3 illustrates an input unit of a remote controller including hot keys according to an embodiment of the present disclosure.

Referring to FIG. 3, the input unit 305 of the remote controller 30 may include at least one for a service-oriented input of room control in the smart hotel control system, at least one of, e.g., a temperature up key [TEMPERATURE: UP(+)] 30a and temperature down key [TEMPERATURE: DOWN(−)] 30b for temperature control, an ON key [LIGHT ON] 30c and OFF key [LIGHT OFF] 30d for illumination control, a do-not-disturb key [DO NOT DISTURB] 30e for requesting a do-not-disturb service (DO NOT DISTURB, DND), and a make-up-room key [MAKE UP ROOM] 30f for a cleaning service, that is make up room (MUR).

The user may transmit a service-oriented input to the gateway 22 or the TV function unit 24 through any one of the hot keys 30a to 30f of the remote controller 30 even while the TV display 26 remains inactivated. Accordingly, the user may simply request to control the illumination and temperature and to clean the room using the remote controller 30 including the service-oriented hot keys as described above even when the user is not watching TV.

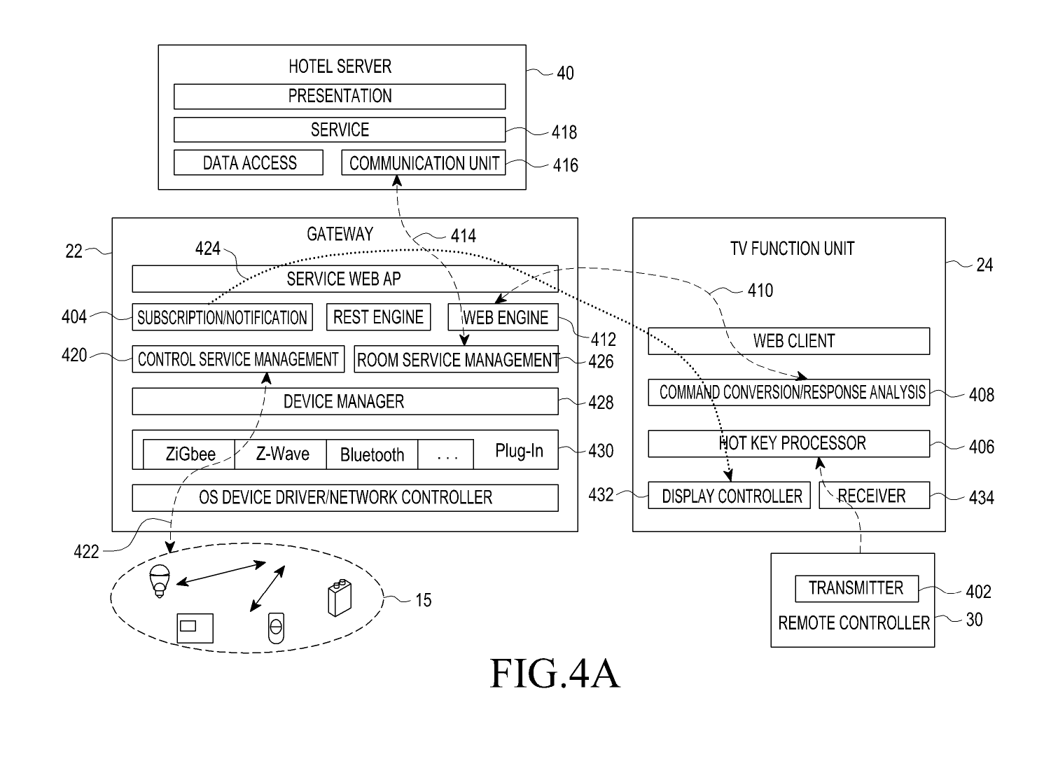

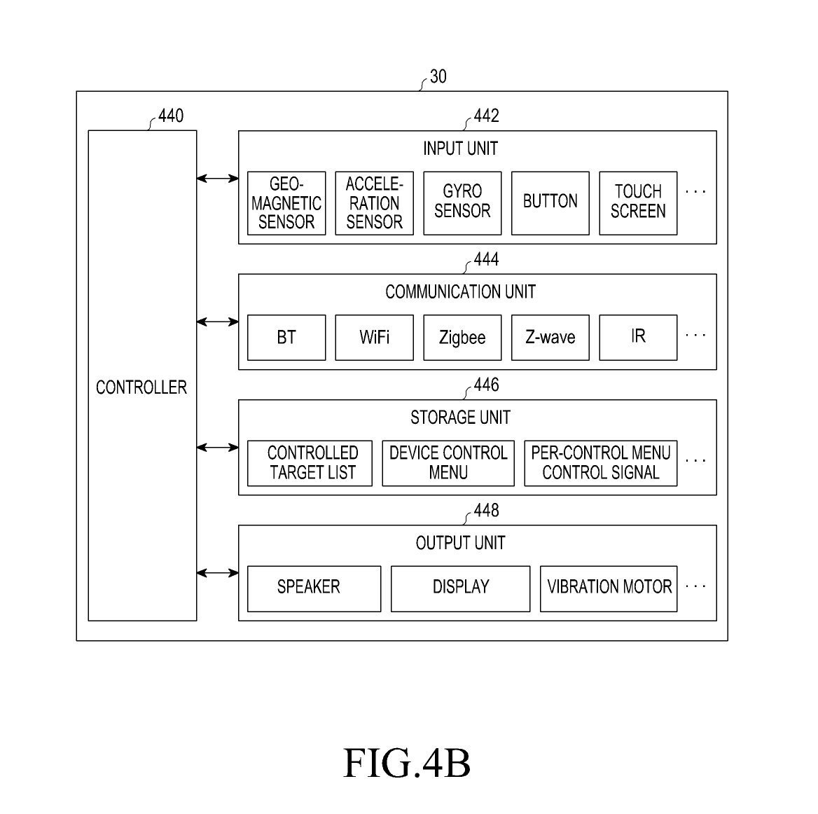

FIG. 4A illustrates a functional configuration of a smart hotel control system according to an embodiment of the present disclosure. It should be noted herein that reference numerals have been assigned to some performing functions according to an embodiment of the present disclosure among various components.

Referring to FIG. 4A, a gateway 22, a TV function unit 24, a remote controller 30, and a management server 40 are shown. The TV function unit 24 communicates with the remote controller 30 according to a TV native function and controls a TV display (not shown). The gateway 22 may be connected with a hotel server (e.g., the management server 40) that may be located outside the room.

The management server 40 includes a presentation function unit, a service function unit 418, a data access unit, and a communication unit 416. The communication unit 416 may communicate with the gateway 22 via a wired or wireless communication means, and as an example, the communication unit 416 may receive a service request for room service from the gateway 22 and transmit a processing result to the gateway 22. The service function unit 418 processes a service as per the service request.

The gateway 22 includes a service web application program interface (API), a subscription/notification unit 404, a representational state transfer (REST) engine, a web engine 412, a control service manager 420, a room service manager 426, a device manager 428, a communication unit 430, and an operation system (OS) device driver/network controller.

The subscription/notification unit 404 may manage information regarding devices subscribing to the gateway 22 and transfer information or messages 424 requiring notification to the TV function unit 24 to be output in a manner that the user may recognize the information or messages. The web engine 412 may communicate with the TV function unit 24, and for example, the web engine 412 may receive a command for device control or service request from the TV function unit 24 and transfer the command to a corresponding object, e.g., the control service manager 420 or room service manager 426.

The control service manager 420 manages control services requiring device control. When receiving the command for device control from the TV function unit 24, the control service manager 420 determines at least one device 15 related to performing the command. The control service manager 420 transmits a control command 422 for performing the command to the at least one determined device 15 through the device manager 428. The control command may be transmitted via a communication scheme, e.g., Wi-Fi, ZigBee, Z-wave, BT, or IR.

When receiving the command for service request from the TV function unit 24, the room service manager 426 transmits the command to the hotel server 40 (414), and when receiving a processing result corresponding to the command from the hotel server 40, transmits the processing result to the TV function unit 24 through the web engine 412 (410).

The TV function unit 24 includes a web client, a command conversion/response analyzer 408, a hot key processor 406, a display controller 432, and a receiver 434. The remote controller 30 includes an input unit (not shown) with multiple keys that may be manipulated by the user and a transmitter 402 transmitting signals input through the keys. The TV function unit 24 may receive a signal from the remote controller 30 through the receiver 434. When the signal corresponds to a hot key input, the signal is transferred to the hot key processor 406. The hot key processor 406 transfers a hot key code corresponding to the signal to the command conversion/response analyzer 408. The command conversion/response analyzer 408 may generate a command for device control or service request corresponding to the hot key code and transfer the same to the gateway 22 and may receive a response corresponding to the command from the gateway 22 and analyze the response (410). The display controller 432 receives information or a message requiring notification from the gateway 22 and provides an output through the TV display 26. Additionally, a non-visible output, e.g., a voice, sound, music, beep, or vibration, corresponding to the information or message may be provided to the user through the TV function unit 24. When the remote controller 30 further includes a receiver for communication with the TV function unit 24 or includes a smartphone, a tablet, or a wearable device, the remote controller 30 may provide feedback corresponding to the information or message to the user through a visible output (e.g., a text or symbol) or non-visible output (e.g., a voice, sound, music, beep, or vibration) according to a request for feedback transmitted from the transmitter of the TV function unit 24.

In an embodiment, the gateway 22 may further include a receiver, a transmitter, and a hot key processor that function in the same manner as the receiver 434, the transmitter, and the hot key processor 406, in order to be able to directly receive and process a key input signal from the remote controller 30. The receiver, the transmitter, and the hot key processor included in the gateway 22 are the same as those described above, and thus, no repetitive description thereof is given.

FIG. 4B illustrates a functional configuration of a remote controller according to an embodiment of the present disclosure.

Referring to FIG. 4B, the remote controller 30 includes a controller 440, an input unit 442, a communication unit 444, a storage unit 446, and an output unit 448. The controller 440 is configured as a processor to control operations by the input unit 442, the communication unit 444, the storage unit 446, and the output unit 448.

The input unit 442 may include at least one of a geo-magnetic sensor, an acceleration sensor, a gyro sensor, a key panel, a touchscreen, and a microphone. Here, the key panel may include at least one hot key like the input unit 305 shown in FIG. 3, as an example.

The communication unit 444 may include at least one of a BT module, a Wi-Fi module, a ZigBee module, a Z-wave module, and an IR module and is in charge of communication between the remote controller 30 and the gateway 22 or the TV function unit 24.

The storage unit 446 stores information regarding the devices 15 registered in the smart hotel control system in a list of controlled targets. The controlled target list may include at least one of, e.g., the name, model name, manufacturer, function, state, and location of each device. The storage unit 446 includes at least one control menu for each device and at least one control signal corresponding to each control menu. Here, the control menu is a command for manipulating the device, and as an example, the control menu for an illumination device includes at least one of control items, such as ON/OFF, brightness up(+)/down(−), and a control signal for each control item is stored in the storage unit 446. As another example, the storage unit 446 may include control items, such as ON/OFF or temperature up(+)/down(−), for the thermostat and control signals corresponding to the control items.

The output unit 448 includes at least one of a speaker, a display, and a vibration motor and may output feedback for device control or service request in the form of, at least one of, a sound, a visible message, or a vibration, under the control of the controller 440.

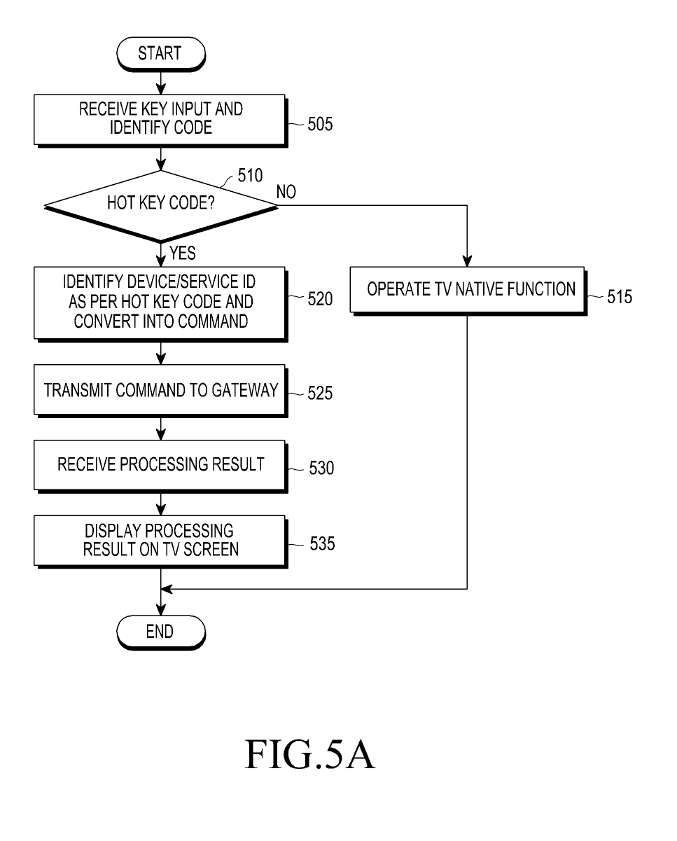

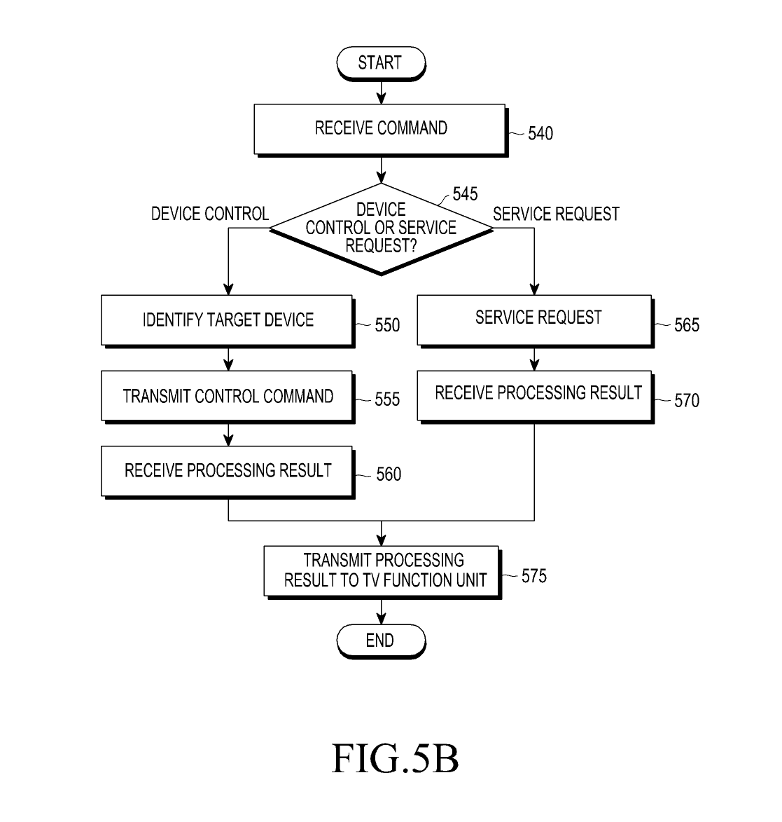

FIG. 5A is a flowchart illustrating an operation of determining a hot key code according to an embodiment of the present disclosure. The flow shown may be performed by, e.g., the TV function unit 24.

Referring to FIG. 5A, the TV function unit 24 receives a key input from the remote controller 30 and identifies a code corresponding to the key input in operation 505. In operation 510, the TV function unit 24 determines whether the determined code is a hot key code. When the determined code is included in a hot key code table previously stored, the TV function unit 24 may determine that the determined code corresponds to a hot key. The following Table 1 represents an example of the hot key code table.

TABLE 1

| | | | BT | | |
|---|---|---|---|---|---|
| | | | | | Usage ID (2 Byte) |
| Name | TV SW Mapping | IR/BT | Page ID | Report ID | little endian |
| ROOM CONTROL | ROOM CONTROL | BT Only | 0xFF70 | 0xF7 | 0x0176 |
| TEMPERATURE+ | TEMPERATURE+ | BT Only | 0xFF70 | 0xF7 | 0x177 |
| TEMPERATURE− | TEMPERATURE− | BT Only | 0xFF70 | 0xF7 | 0x0178 |
| LIGHT ON | LIGHT ON | BT Only | 0xFF70 | 0xF7 | 0x0179 |
| LIGHT OFF | LIGHT OFF | BT Only | 0xFF70 | 0xF7 | 0x0180 |
| DO NOT DISTURB | DO NOT DISTURB | BT Only | 0xFF70 | 0xF7 | 0x0181 |
| MAKE UP ROOM | MAKE UP ROOM | BT Only | 0xFF70 | 0xF7 | 0x0182 |

In Table 1, the hot key codes correspond to [ROOM CONTROL], [TEMPERATURE: +], [TEMPERATURE: −], [LIGHT ON], [LIGHT OFF], [DO NOT DISTURB], and [MAKE UP ROOM], and are transmitted from the remote controller 30 to the TV function unit 24 using BT. A BT signal corresponding to each hot key code includes a page identity (ID), a report ID, and a usage ID.

When the determined code is not a hot key code, the TV function unit 24 goes to operation 515 to perform a TV native function corresponding to the code, e.g., changing channels, adjusting volume, or displaying a menu. In contrast, when the determined code is a hot key code, the TV function unit 24 determines an ID of a service or device mapped to the hot key code based on predetermined mapping information and converts the hot key code into a command corresponding to the determined device or service ID in operation 520. As an example, among the hot key codes exemplified in Table 1, [ROOM CONTROL], [TEMPERATURE: +], [TEMPERATURE: −], [LIGHT ON], and [LIGHT OFF] correspond to device control and may be converted into a command including an ID of at least one device. Further, [DO NOT DISTURB] and [MAKE UP ROOM] correspond to the service request and may be converted into a command including an ID of a service.

In operation 525, the command is transmitted to the gateway 22. The TV display 26 may remain inactivated until the hot key input is received and the command is transmitted in the standby state when the TV native function is not running That is, the TV function unit 24 may process the hot key input and command without activating the TV display. In another embodiment, the TV function unit 24 may activate the TV display 26 that is in the inactivated state when receiving a hot key input and may output through the TV display 26 a message saying “Device control/service request was input” to indicate the requested device control or service request.

When receiving a result of processing the command from the gateway 22 in operation 530, the TV function unit 24 outputs the processing result through the TV display 26 in operation 535. Here, in a case in which the TV display 26 remains inactivated because the TV native function is not performed when the processing result is received (i.e., in the display off state), the TV function unit 24 activates the TV display 26 to output a black screen and outputs a message such as a text or a symbol corresponding to the processing result on the black screen.

Referring to the example shown in Table 1 above, the TV display may display the current temperature and set temperature as the processing result corresponding to the hot key, [TEMPERATURE: +] or [TEMPERATURE: −]. As the processing result corresponding to the hot key, [LIGHT ON] or [LIGHT OFF], the TV display may display the light ON/OFF state for each or a particular zone in the room. As the processing result corresponding to [DO NOT DISTURB] or [MAKE UP ROOM], the TV display may display a text, such as “A do-not-disturb request has applied” or “A MAKE UP request has been taken.”

FIG. 5B is a flowchart illustrating an operation of processing a command according to an embodiment of the present disclosure. The operations of the flowchart shown may be performed by, e.g., the gateway 22.

Referring to FIG. 5B, the gateway 22 receives a command for control of the smart hotel from the TV function unit 24 in operation 540 and determines whether the command is for device control or service request in operation 545. As an example, the gateway 22 may make such determination according to a unique code of the command or depending on whether the command includes at least one device ID or service ID.

When determining that the command is for device control, the gateway 22 determines at least one target device to be controlled according to the command based on previously stored information in operation 550. As an example, when the command indicates device control corresponding to the hot key [TEMPERATURE: +] or [TEMPERATURE: −], the at least one target device may be at least one of an air conditioner, heater and thermostat in the zones of the room. As another example, when the command indicates device control corresponding to the hot key [LIGHT ON] or [LIGHT OFF], the target devices may be lights in the zones of the room. In operation 555, the gateway 22 transmits corresponding control commands to the at least one target device determined. The control commands may be at least one of, e.g., increasing or decreasing temperature or light on or off. The gateway 22 receives a processing result corresponding to the control command from the at least one target device or receives a state report in operation 560, and the gateway 22 transmits the processing result to the TV function unit 24 so that the processing result is output through the TV display 26 in operation 575.

When the command is determined to be for service request, the gateway 22 transfers the command to the hotel server 40 to request to run a service corresponding to the command in operation 565. When receiving the processing result corresponding to running the service from the hotel server 40 in operation 570, the gateway 22 transmits the processing result to the TV function unit 24 so that the processing result is output through the TV display 26 in operation 575.

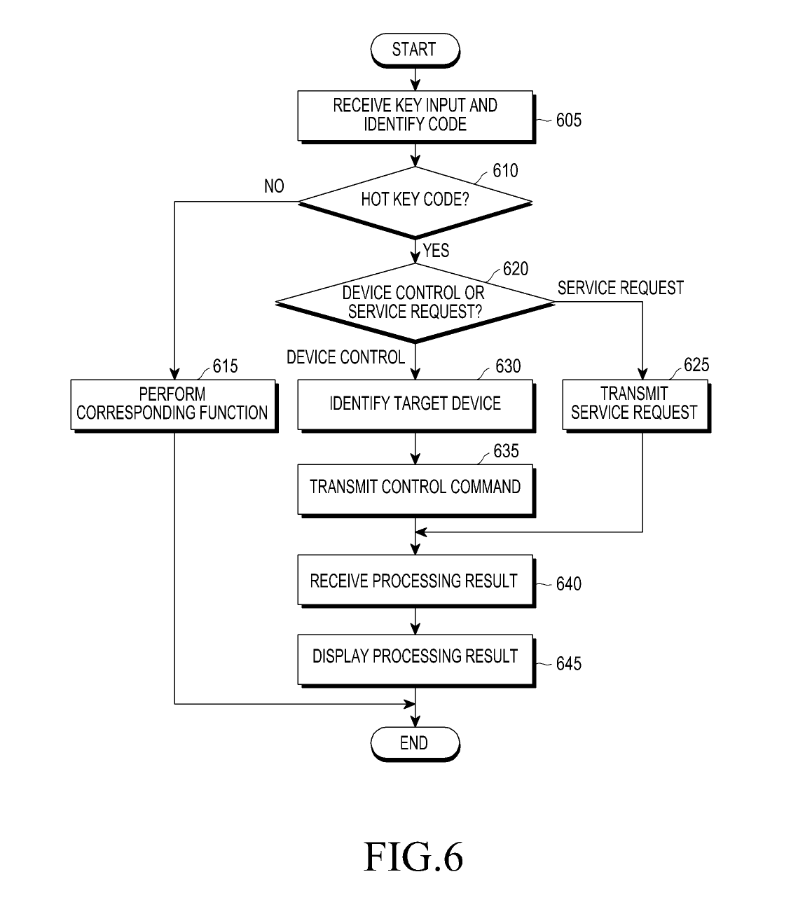

FIG. 6 is a flowchart illustrating an operation of processing a hot key input according to an embodiment of the present disclosure. The operations of the flowchart shown may be performed by, e.g., the gateway 22.

Referring to FIG. 6, the gateway 22 receives a key input directly or via the TV function unit 24 from the remote controller 30 in operation 605 and identifies a code corresponding to the key input. In operation 610, the gateway 22 determines whether the determined code is a hot key code. When the determined code is included in a hot key code table previously stored, the gateway 22 may determine that the determined code corresponds to a hot key. An example of the hot key code table is shown in Table 1.

When the determined code is not a hot key code, the gateway 22 goes to operation 615 to perform a native function corresponding to the code. By contrast, when the determined code is a hot key code, the gateway 22 determines whether the hot key code is for device control or service request based on predetermined mapping information in operation 620.

When determining that the hot key code is for device control, the gateway determines at least one target device to be controlled according to the hot key code in operation 630. As an example, when the hot key code is [TEMPERATURE: +] or [TEMPERATURE: −], the at least target device may be at least one of an air conditioner, heater and thermostat in the zones of the room. As another example, when the hot key code is [LIGHT ON] or [LIGHT OFF], the at least one target device may be at least one of lights in the zones of the room.

In operation 635, the gateway 22 transmits corresponding control commands to the at least one target device determined. The control commands may be at least one of, e.g., increasing or decreasing temperature or light on or off. The gateway 22 receives a processing result corresponding to the control command from the at least one target device or receives a state report in operation 640, and the gateway 22 outputs the processing result through the TV display 26 in operation 645.

When the hot key code is determined to be for service request, the gateway 22 transfers the command to the hotel server 40 to request to run a service corresponding to the command in operation 625. When receiving the processing result corresponding to running the service from the hotel server 40 in operation 640, the gateway 22 outputs the processing result through the TV display 26 in operation 645.

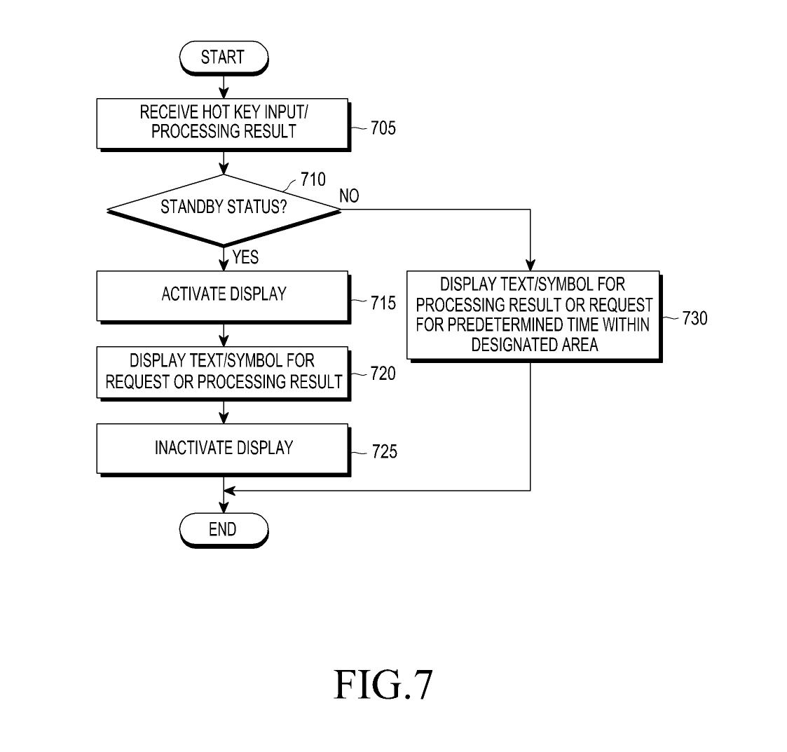

FIG. 7 is a flowchart illustrating an operation of displaying a result of inputting or processing a hot key according to an embodiment of the present disclosure. The operations of the flowchart shown may be performed by, e.g., the TV function unit 24 or the gateway 22. The following description assumes that the flow is performed by the TV function unit 24.

Referring to FIG. 7, the TV function unit 24 receives a hot key input from the remote controller 30 or receives information or a message for notification, e.g., a processing result corresponding to a previously transmitted command, from the gateway 22 or hotel server 40 in operation 705. In operation 710, the TV function unit 24 determines whether the TV display 26 is in the standby state (i.e., the inactivated state), i.e., display-off. When the TV display 26 remains activated, the TV function unit 24 may immediately output a text indicating what has been requested or the processing result corresponding to the hot key input through the TV display 26 in operation 730. In an embodiment, the text may be displayed in an area small enough to only interfere with the TV image on a designated area in the TV display, e.g., a right side or right and lower end thereof. A visible output, such as a symbol or small image, or a non-visible output, such as a sound or vibration, may be provided together or instead of the text, and the text/symbol/image may be displayed during a predetermined scheduled time and may be then left out.

When the TV display 26 is in the standby state, the TV function unit 24 first activates the TV display 26 so that the TV display 26 displays a black screen in operation 715 and outputs the text (or symbol) indicating what has been requested or processing result on the black screen in operation 720. Since no TV image is output, the text may be displayed on the TV display 26 in a relatively large size. In operation 725, the TV function unit 24 may display the text corresponding to the processing result or what has been requested during the predetermined time and may then inactivate the TV display 26 and enable it to turn into the standby state.

As an embodiment, the TV function unit 24 may assign priorities to notification messages from the gateway 22. As an example, the lowest priority, level 1, may include a processing result regarding a light or curtain-related command. The highest priority, level 4, may include notification events, such as a security alert, a fire, or an opening of a door. The TV function unit 24 may differentiate exposure times depending on the priority of the notification message. As an example, the level-4 notification message is output to the TV display 26 while flickering ten seconds. As an example, the level-1 notification message is output to the TV display 26, without flickering, for five seconds.

For reception of material information or security-related notification message, the TV function unit 24 may display a text corresponding to the notification message while additionally outputting a sound. When receiving a notification message relating to a time-dependent service, such as a laundry service, the TV function unit 24 may additionally output an alarm or sound as well. Further, when receiving a notification message relating to illumination control, the TV function unit 24 may display a text corresponding to the notification message, e.g., saying “light is on in the living room,” or may display the location of a corresponding area on the floor plan.

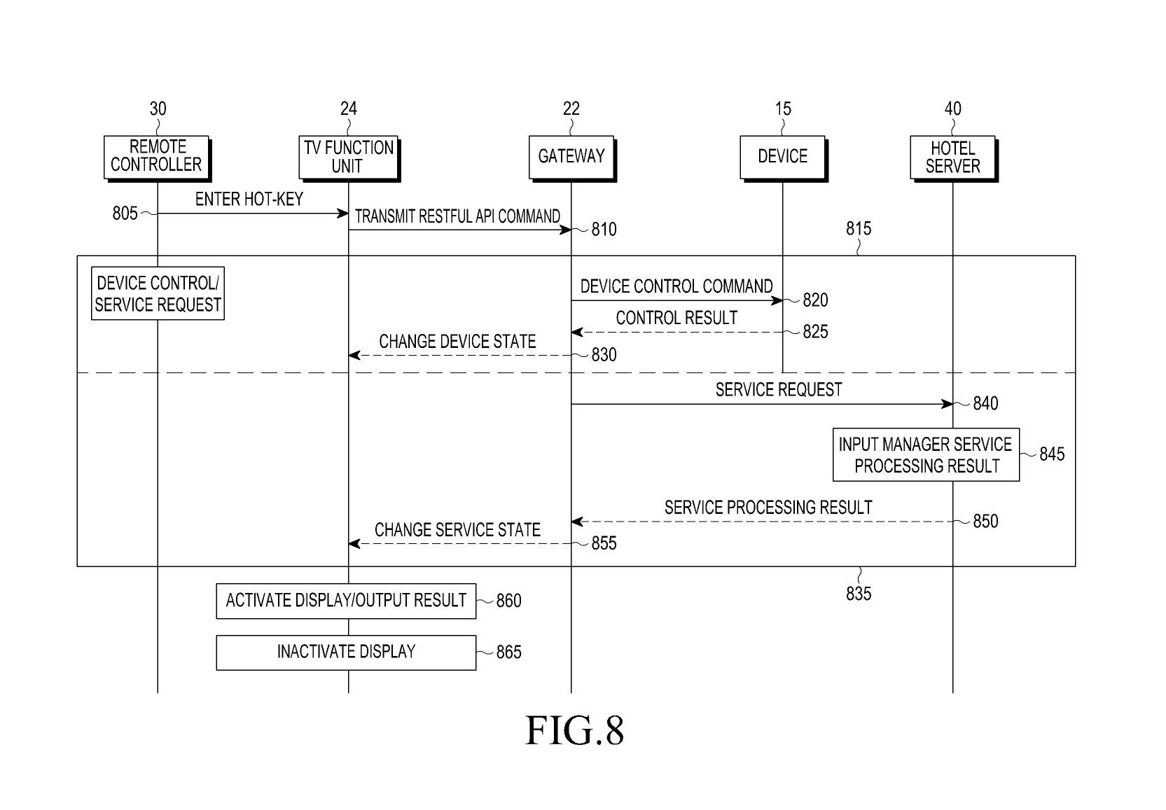

FIG. 8 is a signal flowchart illustrating an operation of processing a service request or device control according to an embodiment of the present disclosure.

Referring to FIG. 8, the remote controller 30 senses a hot key input by the user and transmits a signal corresponding to the hot key input to the TV function unit 24 in operation 805. In operation 810, the TV function unit 24 converts the hot key input into an API command and transmits the API command to the gateway 22. The gateway performs operation 815 when the command is for device control and operation 835 when the command is for service request.

Operation 815 includes the following sub operations. In sub operation 820, the gateway 22 transmits a control command for device control to at least one device 15 relating to the device control. In sub operation 825, the at least one device 15 transmits a processing result corresponding to the control command to the gateway 22 in response to the completion of the control command or according to a periodic/aperiodic reporting scheme. In sub operation 830, the gateway 22 transfers the processing result to the TV function unit 24. The processing result corresponding to the device control may indicate a change in the state of the target device (e.g., a temperature change or light on/off).

Operation 835 includes the following sub operations. In sub operation 840, the gateway 22 transmits a command for service request to the hotel server 40. In sub operation 845, the hotel server 40 may receive a processing result for the service request from the operator and transmit the processing result to the gateway 22 in sub operation 850. In sub operation 855, the gateway 22 transfers the processing result to the TV function unit 24. The processing result corresponding to the service request may be a change in the service state, e.g., “Make up room was complete.”

In operation 860, when the TV display 26 is in the standby state, the TV function unit 24 activates the TV display 26 and outputs the processing result through the TV display 26. A predetermined time after the processing result has been displayed, the TV function unit 24 may restore the state of the TV display 26, i.e., inactivate the TV display 26, in operation 865. In case the TV display 26 remains activated and is outputting a TV image according to a TV native function when the processing result is received, the TV function unit 24 may display the processing result on a small designated area of the TV display 26.

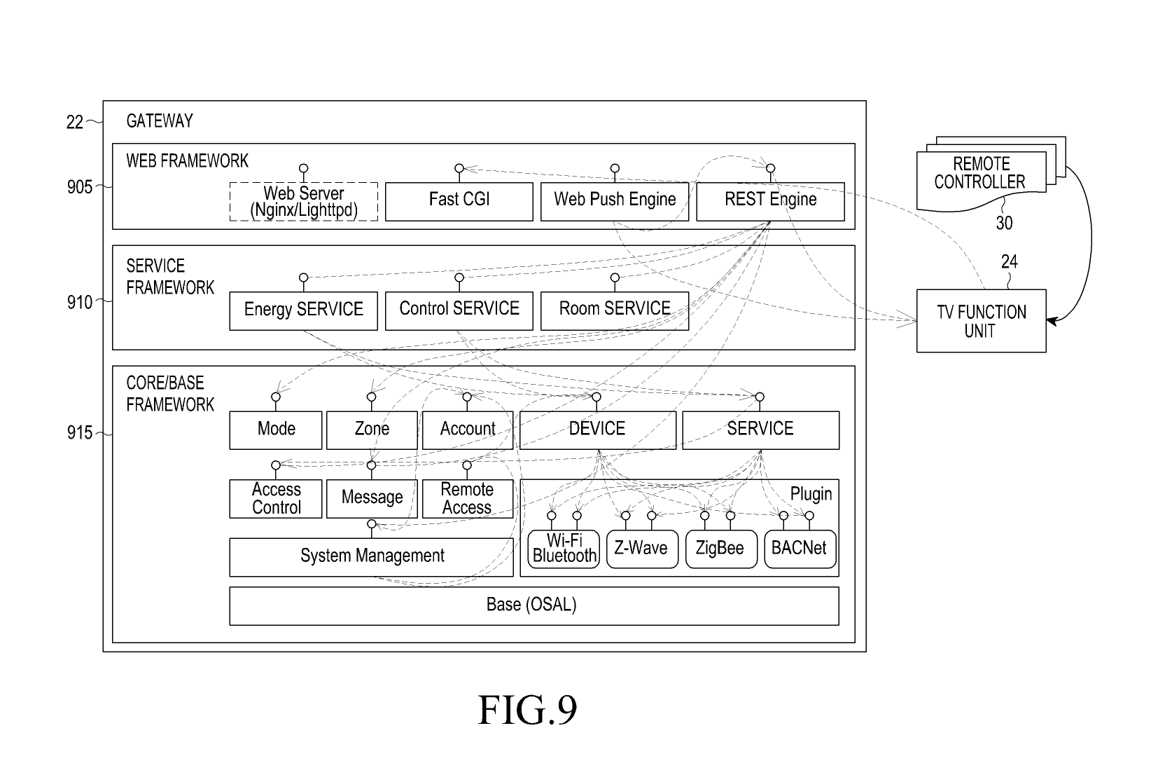

FIG. 9 illustrates a functional configuration of a gateway according to an embodiment of the present disclosure.

Referring to FIG. 9, the gateway 22 includes a web framework 905, a service framework 910, and a core & base framework 915. The web framework 905 includes a high-speed common gateway interface (CGI) module for communication with the TV function unit 24, a web push engine, and a REST engine. The service framework 910 includes an energy service module, a control service module, and a room service module. The core & base framework 915 includes a mode module, a zone module, a billing (account) module, a system management module, a device module, a service module, and a communication module.

The TV function unit 24 converts the hot key input received from the remote controller 30 into an API command and transfers the API command to the web framework 905 of the gateway 22. The REST engine of the web framework 905 analyzes the API command, determines a service corresponding to the API command, and calls the control service module or room service module of the service framework 910. The control service module obtains detailed information corresponding to a device ID to be controlled according to the API command from the device module of the core & base framework 915 and requests a control service for the device to be controlled. The room service module of the service framework 910 transmits the service ID according to the API command to the hotel server 40 and receives a processing result for the service ID. In an embodiment, the hotel server 40 provides notification by displaying the command of the service ID to a control console or webpage of the hotel manager and receives a processing result from the hotel manager.

When the API command indicates illumination control for the zones in the room, a zone module of the core & base framework 915 controls a light corresponding to a zone ID included in the API command. When the API command indicates group control on the devices in the room, a mode module obtains a mode ID by determining the mode for the group control and performs group control corresponding to the obtained mode ID.

Examples of API commands received by the gateway 22 are as follows.

/devices/{device_id}/temperatures is a command to set and get specific information of temperatures, and examples of request format are as follows.

```
“Temperatures”, [
  {
  “id”, “id1”,
  “desired”, 3.0,
  “unit”, “Celsius”
  },
  {
  “id”, “id2”,
  “desired”, 4.0,
  “unit”, “Celsius”
  }
]
```

/devices/{device_id}/thermostat is a command to set and get specific information of a thermostat, and examples of a request format are as follows.

```
“Thermostat”,
  {
  “thermostatMode”,
  [
    “thermostat_cool”
  ],
  “fanMode”,
  [
    “fan_on_low”
  ]
  }
```

/zones/{zone_id} is a command to set and get general information of a zone light device, and examples of a request format are as follows.

```
“Zone”, {
    “lightState”, “On”
  }
```

/room is a command to set and get room information, and examples of a request format are as follows.

```
“Room” ,{
  “housekeeping” , true/false,
  “needSendNotification”,true/false
}
“Room” ,{
  “doNotDisturb” , true/false,
  “needSendNotification”,true/false
}
```

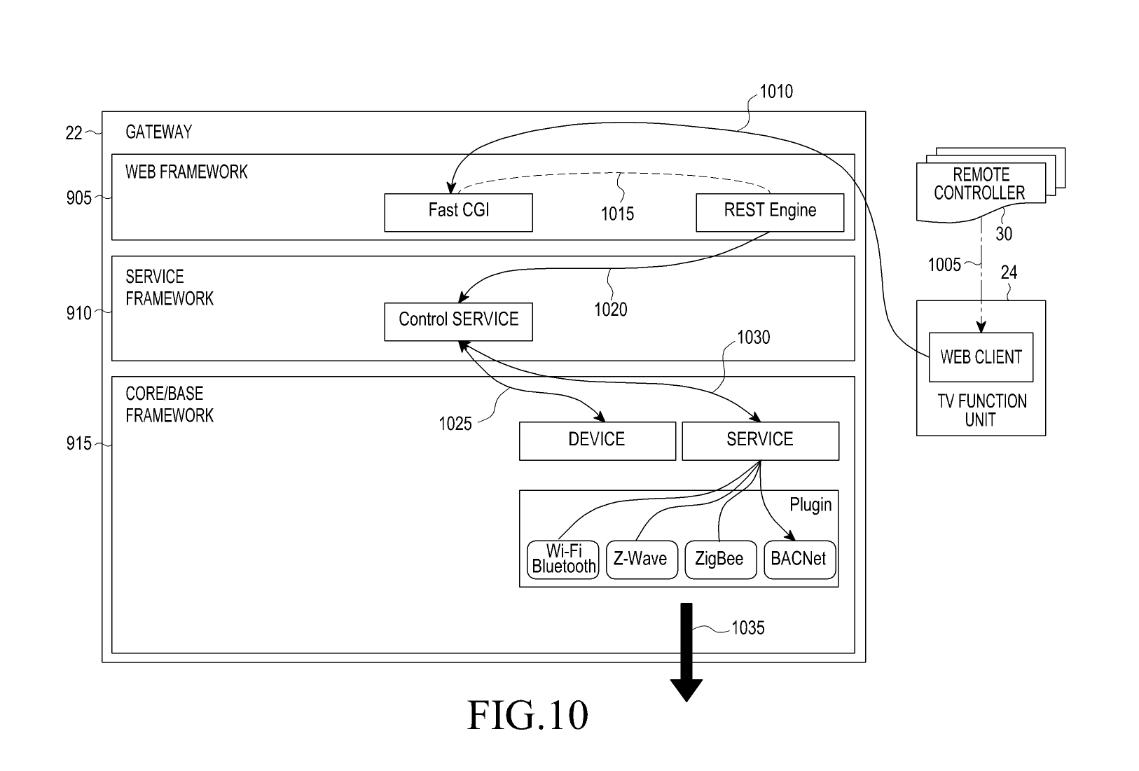

FIG. 10 illustrates a procedure of running a device control command in a gateway according to an embodiment of the present disclosure.

Referring to FIG. 10, the gateway 22 includes a web framework 905, a service framework 910, and a core & base framework 915.

The web client of the TV function unit 24 receives a hot key input from the remote controller 30 through, e.g., BT (1005). The web client transfers a command corresponding to the hot key input to a high-speed CGI module in the web framework 905 linked to a corresponding CGI thread (1010). The high-speed CGI module transmits a request corresponding to the command to the REST engine (1015). The REST engine identifies that the request is for device control and transmits a control request to the control service module of the service framework 910 (1020).

The control service module obtains detailed information, such as the device type, name, and connection, corresponding to the device to be controlled from the device module of the core & base framework 915 in response to the control request (1025) and sends a request for a control service, such as power on/off, temperature up/down, or open/close a curtain (drape open/close) for the device to be controlled, to the service module (1030). The request for the control service is transferred from the service module to the communication module, and the communication module converts the request for the control service into a control command fitting a communication protocol of the corresponding device, such as ZigBee or Z-wave, and transmits the same to the corresponding device (1035).

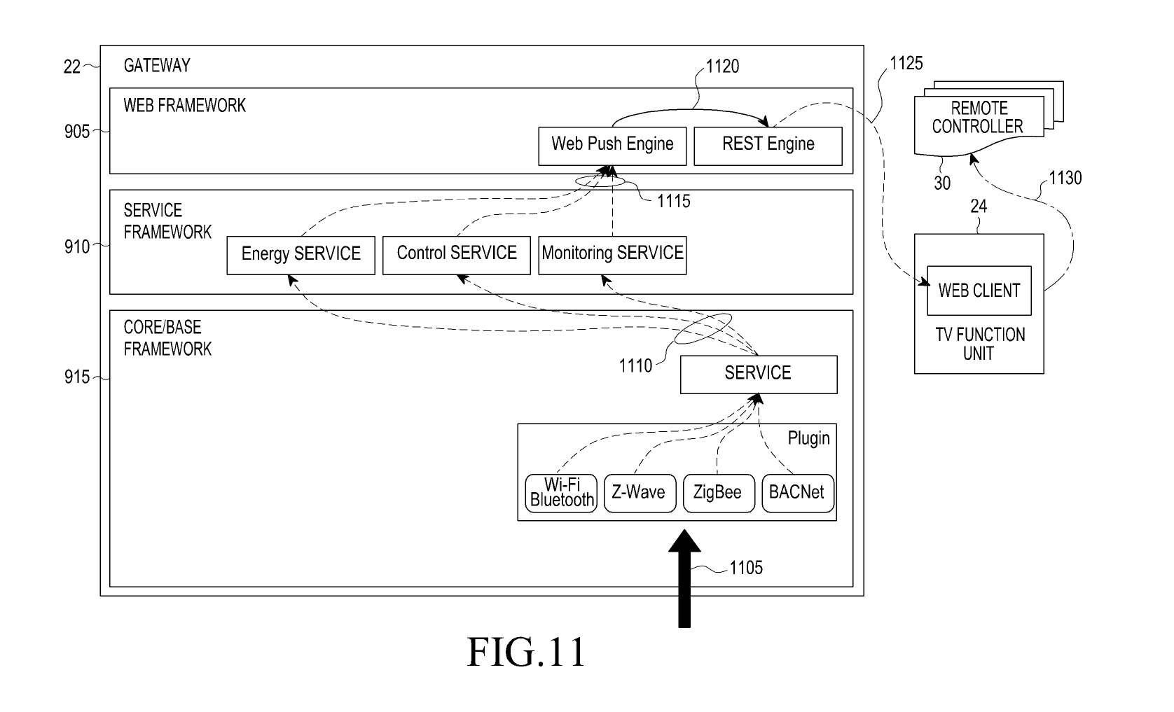

FIG. 11 illustrates a procedure of receiving a result of varying a device state in a gateway according to an embodiment of the present disclosure.

Referring to FIG. 11, the gateway 22 includes a web framework 905, a service framework 910, and a core & base framework 915.

The device may transfer a device status changed result to the gateway 22 periodically/aperiodically or in response to a control command from the gateway 22 (1105). Upon receiving the state changed result, the communication unit of the core & base framework 915 generates a device state changed event. The service module transfers the device state changed event to the control service module of the service framework 910 (1110), and the control service module transfers the device state changed event to the web push engine of the web framework 905 (1115). The web push engine transmits a notification according to the device state changed event to the REST engine (1120), and the REST engine sends a response including the state changed result to the TV function unit 24 in response to the notification (1125). The TV function unit 24 may output the state changed result to the TV display, and/or, as possible, may transmit a notification message including the state changed result to the remote controller 30 through BT (1130). When the remote controller 30 has an output means, such as a speaker or display, the remote controller 30 may output the state changed result to be noticeable to the user.

The following Table 2 represents examples of the state changed events.

TABLE 2

| Event | Description |
|---|---|
| PowerStateChangeEvent | indicates a change in the power state of the device, ON->OFF, |
| | OFF->ON. (This event occurs when there is a change in the |
| | power state of device. On to Off, Off to On) |
| ModeStateChangeEvent | indicates a change in the operation mode of the device (This |
| | event occurs when there is a change in the operation mode of |
| | the device) |
| DoorStateChangeEvent | indicates that refrigerator door is opened. (This event occurs |
| | when refrigerator door is opened.) |
| TemperatureChangeEvent | indicates that the temperature of device is changed. (This |
| | event occurs when there is a change in the temperature of |
| | device.) |
| OperationStateChangeEvent | indicates that an operation error occurs in the device. (This |
| | event occurs when there is an operation error in the device.) |
| BatteryLevelChangeEvent | indicates charging the battery is required. (This event occurs |
| | when there is a need to charge the battery.) |
| MotionDetectionEvent | indicates that a motion is detected. (This event occurs when |
| | motion is detected.) |
| FanModeChangeEvent | indicates that the fan mode for controlling temperature is |
| | changed. (This event occurs when fan mode of thermostat is |
| | changed.) |
| FanStateChangeEvent | indicates that the fan state for controlling temperature is |
| | changed. (This event occurs when fan state of thermostat is |
| | changed.) |
| ThermostatModeChangeEvent | indicates that the mode for controlling temperature is |
| | changed. (This event occurs when mode of the thermostat is |
| | changed.) |
| ThermostatSetPointChangeEvent | indicates that a set value for controlling temperature is |
| | changed. (This event occurs when Set Point of thermostat is |
| | changed.) |

An example of a notification for state change transmitted from the web push engine is shown below.

```
{
  “LongPollingNotification”, {
  “Events”, [
    {
    “SubDevices”, [
      {
      “Operation”, {
        “power”, “On”
      },
      “id”, 1
      }
    ],
    “eventTime”, “2015-06-09T12,25,51”,
```

| | |
|---|---|
| “resourceURI”, | “/devices/a747a355-5304-445e-a0ef- |

```
80372a01361c/subdevices/1/operation”,
          “uuid”, “ef84592b,5”
        },
        {
          “SubDevices”, [
          {
            “Operation”, {
            “power”, “On”
            },
            “id”, 1
          }
          ],
          “eventTime”, “2015-06-09T12,25,51”,
```

| | |
|---|---|
| “resourceURI”, | “/devices/298a29bd-9ef8-423c-a6cf- |

```
99ea238eb935/subdevices/1/operation”,
          “uuid”, “ef84592b,10”
        },
        {
          “SubDevices”, [
          {
            “Operation”, {
            “power”, “On”
            },
            “id”, 2
          }
          ],
          “eventTime”, “2015-06-09T12,25,51”,
```

| | |
|---|---|
| “resourceURI”, | “/devices/ac433122-b434-4cb3-bebe- |

```
4983aa0ce49e/subdevices/2/operation”,
        “uuid”, “ef84592b,11”
        },
        “eventTime”, “2015-06-09T12,25,51”,
```

| | |
|---|---|
| “resourceURI”, | “/devices/7bb0760c-e1de-4502-a4a1- |

```
cd80e1b6002b/subdevices/1/operation”,
        “uuid”, “ef84592b,2”
        }
      ],
      “subscriptionId”, “9f3452d1-a93e-48f8-8362-5e96dc935eb8”
      }
    }
```

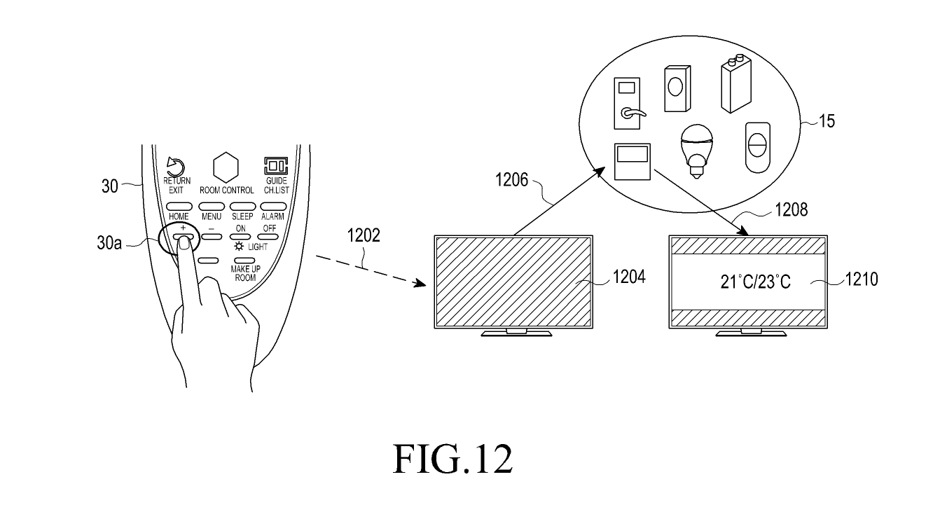

FIG. 12 is a view illustrating a procedure of processing device control according to an embodiment of the present disclosure.

Referring to FIG. 12, the remote controller 30 detects an input for a hot key, e.g., [TEMPERATURE: +] 30a, for device control and transmits a key input signal corresponding to the detected key input to the gateway 22 (1202). When the TV display 26 is inactivated (1204), the gateway 22 may activate the TV display 26 to output a text, such as “[TEMPERATURE: +] has been inputted” or “Room temperature will be up.”

The gateway 22 transmits a control command for increasing temperature to the target device 15, a thermostat, corresponding to the key input signal (1206). As an example, the control command may indicate to increase the temperature by one degree or to increase a preset temperature by one degree. The thermostat runs heating according to the control command and transmits the result to the gateway 22 (1208). As an example, the processing result may indicate the completion of processing or the current temperature or set temperature. Then, the gateway 22 outputs a text corresponding to the processing result, e.g., [CURRENT TEMPERATURE: 21° C./SET TEMPERATURE: 23° C.], to the TV display 26 (1210). However, this is merely an example, and different notifications for state change may be configured according to various embodiments.

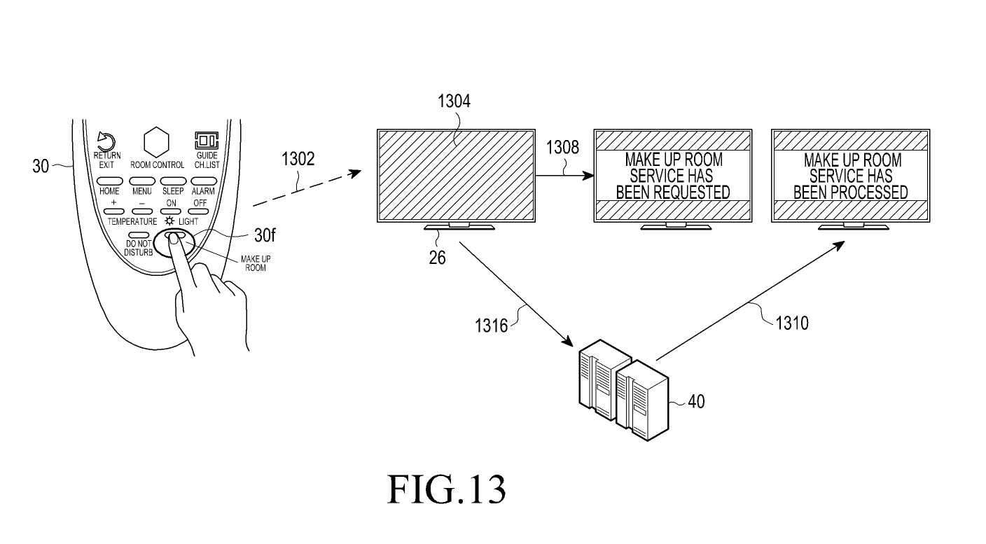

FIG. 13 is a view illustrating a procedure of processing a service request according to an embodiment of the present disclosure.

Referring to FIG. 13, the remote controller 30 detects an input for a hot key, e.g., [MAKE UP ROOM] 30f, for service request and transmits a key input signal corresponding to the detected key input to the gateway 22 (1302).

The gateway 22 transmits a service request corresponding to the key input signal to the management server 40 (1316). The service request may include, e.g., a service ID corresponding to the MAKE UP ROOM service. When the TV display 26 remains inactivated (1304), the gateway 22 may activate the TV display 26 to output a text, such as “[MAKE UP ROOM] service has been requested.” (1308). The management server 40 processes the service request and transmits the result to the gateway 22 (1310). The gateway 22 then outputs a text corresponding to the processing result, e.g., “[MAKE UP ROOM] service has been processed” to the TV display 26.

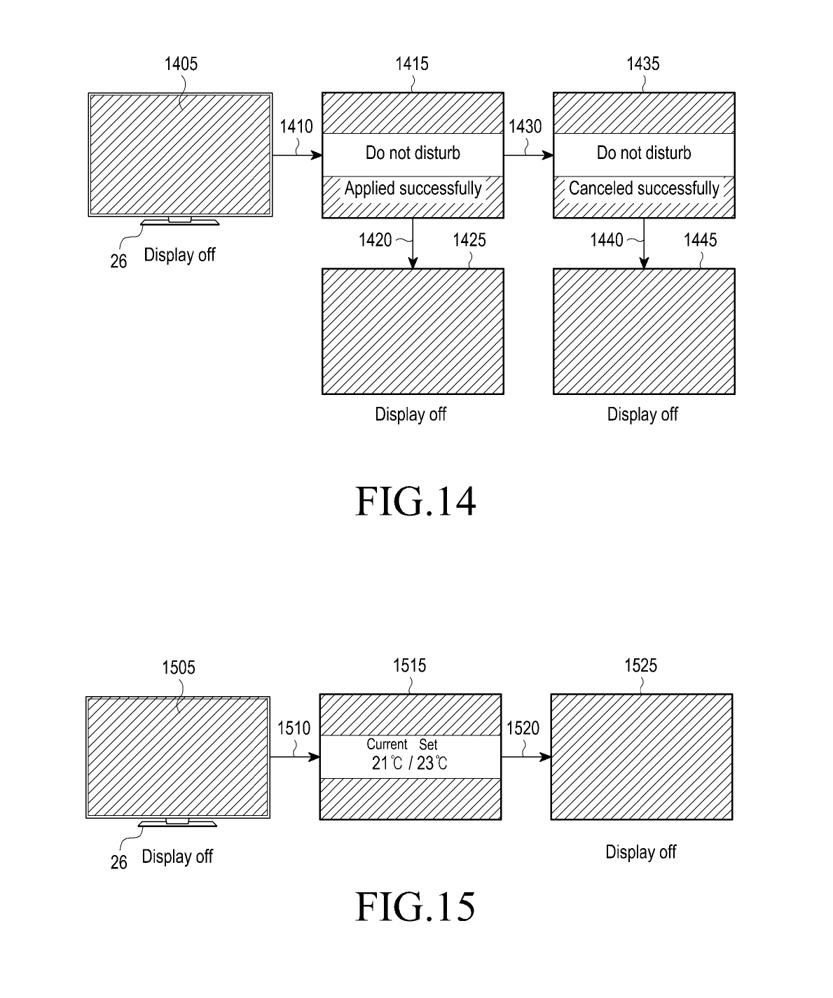

FIG. 14 illustrates a screen of a TV display to indicate a change in the state of a service request according to an embodiment of the present disclosure. Here, an example of requesting the service of housekeeping has been shown here.

Referring to FIG. 14, the TV display 26 remains inactivated in the standby state (1405). Here, the housekeeping status is “No request.” When receiving a hot key input, [DO NOT DISTURB], through the remote controller 30 while the TV display 26 remains inactivated (1410), the TV function unit 24 may activate the TV display 26 to display, through the TV display 26, a text indicating the housekeeping status corresponding to the hot key input, e.g., “Do not disturb/Applied successfully.” (1415). Here, the housekeeping status becomes “Do not disturb.” Additionally, the TV display 26 may further display, e.g., “Press the DO NOT DISTURB button repeatedly to set on or off” as guidance text to change the requested housekeeping status. The information regarding the housekeeping status is transferred through the gateway 22 to the hotel server 40.

In screen 1415, when any one of [RETURN], [EXIT], and [POWER] is input through the remote controller 30 or when a predetermined time (e.g., five seconds) elapses without any input through the remote controller 30 (1420), the TV function unit 24 inactivates the TV display 26 to remove the text and returns to the standby state (1425). Here, the housekeeping status is still “Do not disturb.”

In screen 1415, when the hot key input, [DO NOT DISTURB], is received again through the remote controller 30 (1430), the TV function unit 24 changes the text of the TV display 26 into “Do not disturb/Canceled successfully” and changes the housekeeping service status into “No request.” (1435). The information regarding the change in the housekeeping status is transferred through the gateway 22 to the hotel server 40. Likewise, the TV display 26 may further display, e.g., “Press the DO NOT DISTURB button repeatedly to set on or off” as guidance text to change the housekeeping status.

In screen 1435, when any one of [RETURN], [EXIT], and [POWER] is input through the remote controller 30 or when a predetermined time (e.g., five seconds) elapses without any input through the remote controller 30 (1440), the TV function unit 24 inactivates the TV display 26 to remove the text and returns to the standby state (1445). Here, the housekeeping status is still “No request.”

FIG. 15 illustrates a screen of a TV display to indicate a change in temperature according to an embodiment of the present disclosure.

Referring to FIG. 15, while the TV display 26 remains inactivated in the standby state (1505) and when receiving a hot key input related to a temperature setting, e.g., [TEMPERATURE: +] or [TEMPERATURE: −], through the remote controller 30 (1510), the TV function unit 24 may activate the TV display 26 to display a text indicating a temperature controlled state, e.g., “Current 21° C./Set 23° C.,” corresponding to the hot key input through the TV display 26 (1515).

In screen 1515, when receiving an input, [TEMPERATURE: +] or [TEMPERATURE: −], through the remote controller 30, the TV function unit 24 transmits a command corresponding to the input, e.g., a command corresponding to increasing or decreasing the temperature, to the gateway 22. The gateway 22 then transmits a control command corresponding to increasing or decreasing the temperature to a corresponding device, i.e., at least one of an air conditioner, heater, or thermostat. In an embodiment, the gateway 22 may determine that the user is located in the zone where the controller 20 is installed, e.g., the living room, and may transmit the control command to the air conditioner, heater, and thermostat relating to the living room.

In screen 1515, when any one of [RETURN], [EXIT], and [POWER] is input through the remote controller 30, when a predetermined time (e.g., five seconds) elapses without any input through the remote controller 30, or when no temperature-related hot key input is received through the remote controller 30 for a predetermined time (1520), the TV function unit 24 inactivates the TV display 26 to remove the text and returns to the standby state (1525).

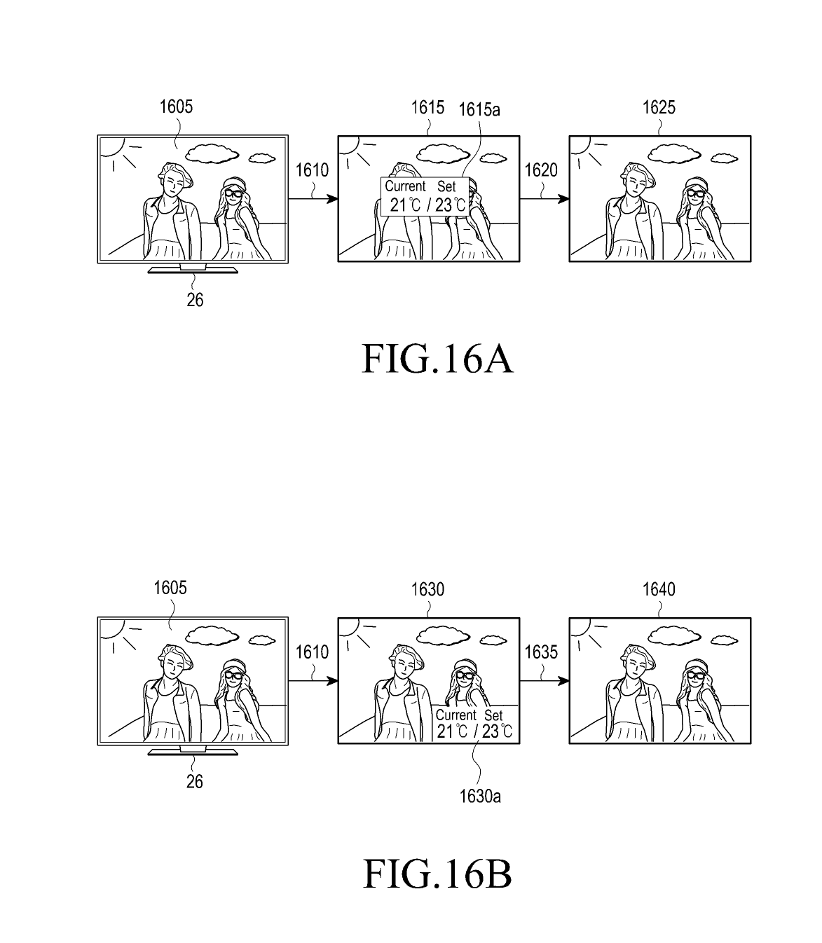

FIGS. 16A and 16B illustrate screens of a TV display outputting a processing result while a TV function remains activated according to various embodiments of the present disclosure.

Referring to FIG. 16A, the TV display 26 remains activated and is outputting a TV image by a TV native function (1605). When one of the hot keys, e.g., [TEMPERATURE: +], is input through the remote controller 30 while the TV display 26 remains activated (1610), the TV function unit 24 displays, on the TV image, a message 1615a including a text corresponding to the hot key input, e.g., “Current 21° C./Set 23° C.,” (1615). The message 1615a may be processed to be semi-transparent not to interfere with the TV image. In screen 1615, when any one of [RETURN], [EXIT], and [POWER] is input through the remote controller 30 or when a predetermined time (e.g., five seconds) elapses without any input through the remote controller 30 (1620), the TV function unit 24 removes the text from the screen of the TV display 26 and continues to display the original TV image (1625).

Referring to FIG. 16B, when one of the hot keys, e.g., [TEMPERATURE: +], is input through the remote controller 30 while the TV display 26 remains activated (1605), the TV function unit 24 displays a message 1630a including a text corresponding to the hot key input, e.g., “Current 21° C./Set 23° C.,” on a predetermined area of the screen of the TV display 26, e.g., at a right side or right and lower end thereof (1630). The message 1630a may occupy a relatively smaller area not to interfere with the TV image. For example, the message 1630a may be semi-transparently overlaid on the TV image. As another example, the TV function unit 24 may output the TV image, with the TV image shrunken or partially removed from the screen of the TV display 26 and may display the text in the remaining area resulting from the shrunken TV image. In screen 1630, when any one of [RETURN], [EXIT], and [POWER] is input through the remote controller 30 or when a predetermined time (e.g., five seconds) elapses without any input through the remote controller 30 (1635), the TV function unit 24 removes the text from the screen of the TV display 26 and recovers and displays the original TV image (1640).

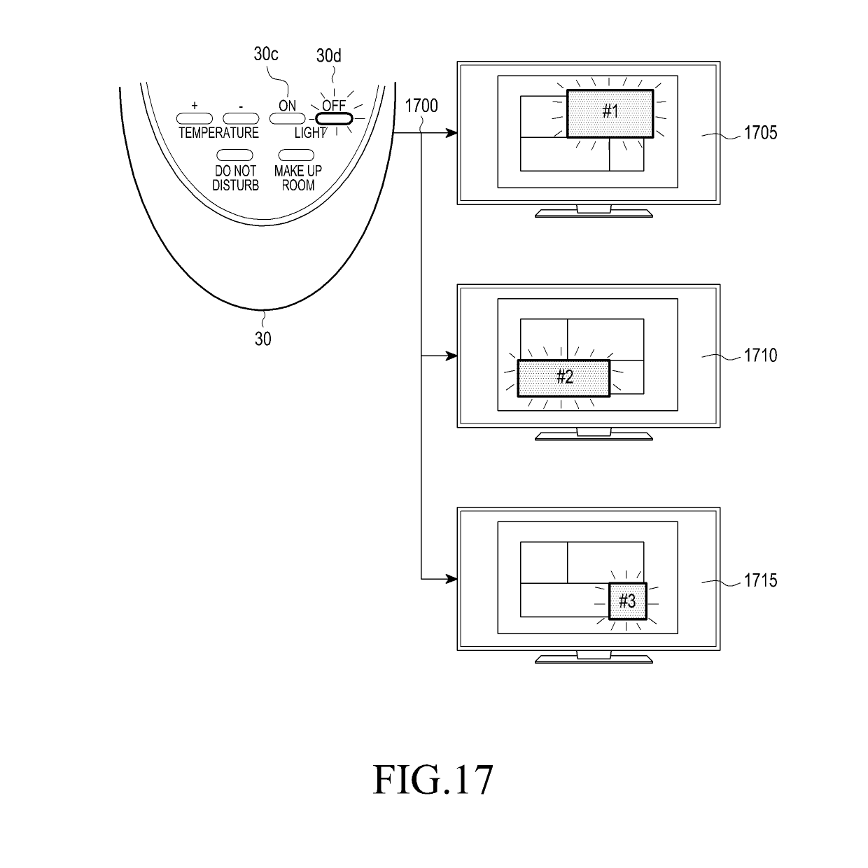

FIG. 17 illustrates a scheme of processing a hot key input according to an embodiment of the present disclosure.

Referring to FIG. 17, when receiving a particular hot key, e.g., [LIGHT ON] 30c or [LIGHT OFF] 30d, through the remote controller 30 (1700), the TV display 26 outputs a layout including the zones inside the room. Whenever the same hot key is inputted, the TV display 26 may sequentially vary and highlight the zones to be controlled in the layout. As an example, when [LIGHT ON] or [LIGHT OFF] is first input (1700), zone #1 set as default on the layout is displayed highlighted (e.g., flickering, enlarging, moving, placing the cursor) (1705), and when the same hot key is input again, zone #2 is highlighted (1710), and when the same hot key is input once more, zone #3 is highlighted (1715).

While a desired zone is selected, the user may allow device control corresponding to the desired zone, i.e., light on/off, to be performed by entering a key corresponding to Exit or OK through the remote controller 30 or waiting a predetermined time-out time without any action. As an example, when receiving an OK key input or no input for five minutes from the remote controller 30 while the layout as shown in screen 1710 is displayed by repeatedly inputting [LIGHT OFF] 30d (1700), the TV function unit 24 transmits a light-off command for zone #2 to the gateway 22. Accordingly, the gateway 22 transmits a light-off control command to the lighting device in zone #2. In an embodiment, the gateway 22 detects reception of an OK key input or no input for five minutes from the remote controller 30 while the layout as shown in screen 1710 is displayed and transmits a light-off control command to the lighting device in zone #2.

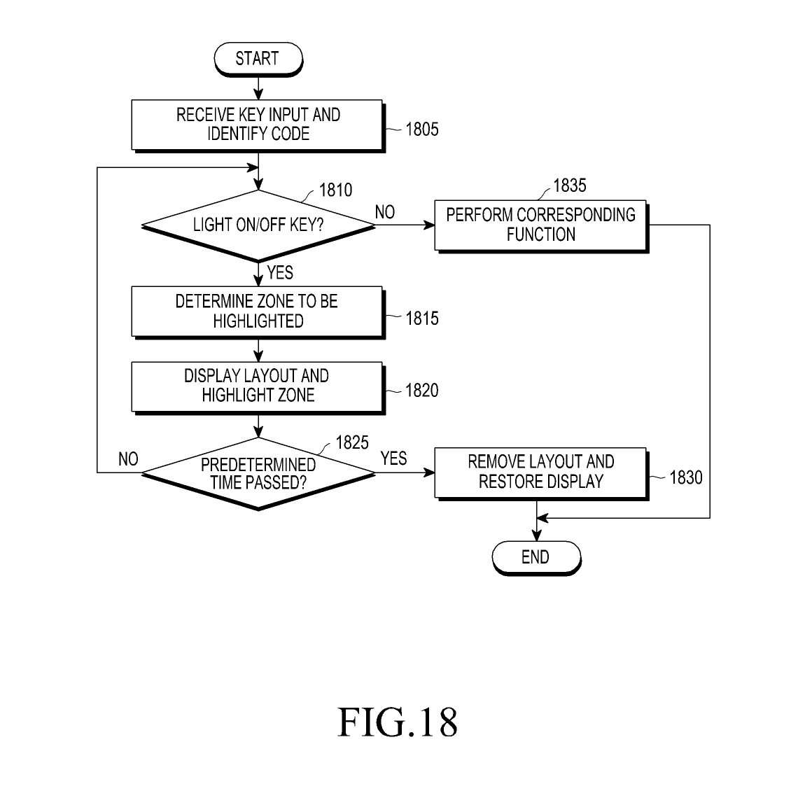

FIG. 18 is a flowchart illustrating an operation of controlling illumination according to an embodiment of the present disclosure.

Referring to FIG. 18, the TV function unit 24 receives a key input from the remote controller 30 and identifies a code corresponding to the key input in operation 1805. In operation 1810, the TV function unit 24 determines whether the determined code corresponds to light on/off. When the determined code has a code value corresponding to light on/off, when the determined code does not correspond to light on/off, the TV function unit 24 performs a function corresponding to the code in operation 1835.

By contrast, when the determined code corresponds to light on/off, the TV function unit 24 determines a zone to be highlighted among the zones in the room in operation 1815. The zone may have a default zone ID, e.g., #1, may be determined as a zone that is currently in a light-on or light-off state, or may have a zone ID next to the zone previously highlighted. In operation 1820, the TV function unit 24 outputs a layout including the zones in the room through the TV display and highlights the determined zone (e.g., by flickering or coloring). When the same key input is not received until a predetermined time-out time elapses in operation 1825, the TV function unit 24 stops outputting the layout through the TV display and restores the TV display in operation 1830.

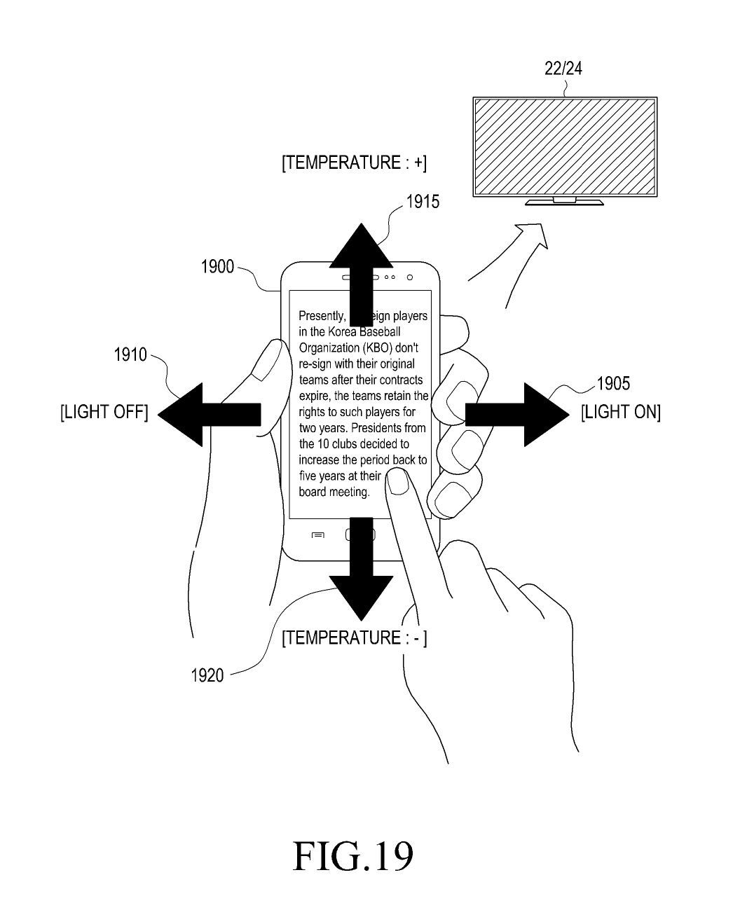

FIG. 19 illustrates a hot key input by a mobile terminal operating as a remote controller according to an embodiment of the present disclosure. Shown here is an example in which the mobile terminal is implemented as a smartphone 1900.

Referring to FIG. 19, the smartphone 1900 is a mobile terminal equipped with a remote control application that may communicate with the TV function unit 24, and the smartphone 1900 may output at least one hot key for remote control of a smart hotel as described above by running the application. Additionally, the smartphone 1900 may operate as a room key interworking with the door lock of the hotel room. The user may access the gateway 22 through the smartphone 1900 to authenticate the smartphone 1900 and to download a hot key setting for the hotel room. The smartphone 1900 may then provide a hot key input screen and layout optimized per hotel room to allow the user to more easily control the hotel room.

As another embodiment, the smartphone 1900 may support a simplified hot key input according to the number of touches, direction of a slide, or motion input by the user while running its native function (e-book in the example shown). According to the example shown, when detecting a right-directional slide input 1905 while running its native function, the smartphone 1900 determines that a hot key, [LIGHT ON], has been inputted. When detecting a left-directional slide input 1910, the smartphone 1900 determines that a hot key, [LIGHT OFF], has been inputted. When detecting an upper-directional slide input 1915, the smartphone 1900 determines that a hot key, [TEMPERATURE: +], has been inputted. And, when detecting a lower-directional slide input 1920, the smartphone 1900 determines that a hot key, [TEMPERATURE: −], has been inputted.

The smartphone 1900 may transmit a hot key input by the user to the gateway 22 or the TV function unit 24 in the same manner as the above-described remote controller 30. Further, when receiving a processing result for a control command or state changed result for the hotel room from the gateway 22 or the TV function unit 24, the smartphone 1900 may display the processing result or state changed result on its own screen or through the TV display 26.

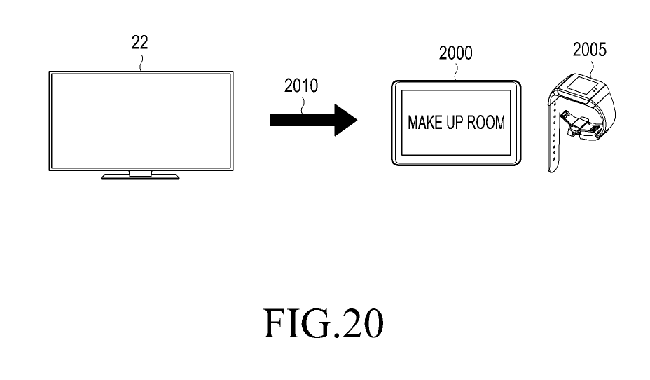

FIG. 20 illustrates other examples of a remote controller according to an embodiment of the present disclosure.

Referring to FIG. 20, a TV or mobile terminal (not shown), as well as a tablet computer 2000, a wearable device 2005, etc., which may establish a session with the gateway 22, may be implemented as the remote controller 30, and the remote controller 30 implemented as described above may output a voice, sound, beep, or vibration in response to a processing result feedback 2010 from the gateway 22 or the TV function unit 24.

There have been described thus far various embodiments in which a remote controller is provided with hot keys to control devices in a hotel room. In the above-described various embodiments, a limitation is imposed on the number of devices intending to perform control or service request since the size of the remote controller is limited. Further, since the provided hot keys have unchanged functions, it is difficult to add a new device or service.

In the following various embodiments, soft mapping is supported for hot keys of the remote controller. In other words, a guide for adaptive hot key mapping may be provided using a limited keypad of the remote controller.

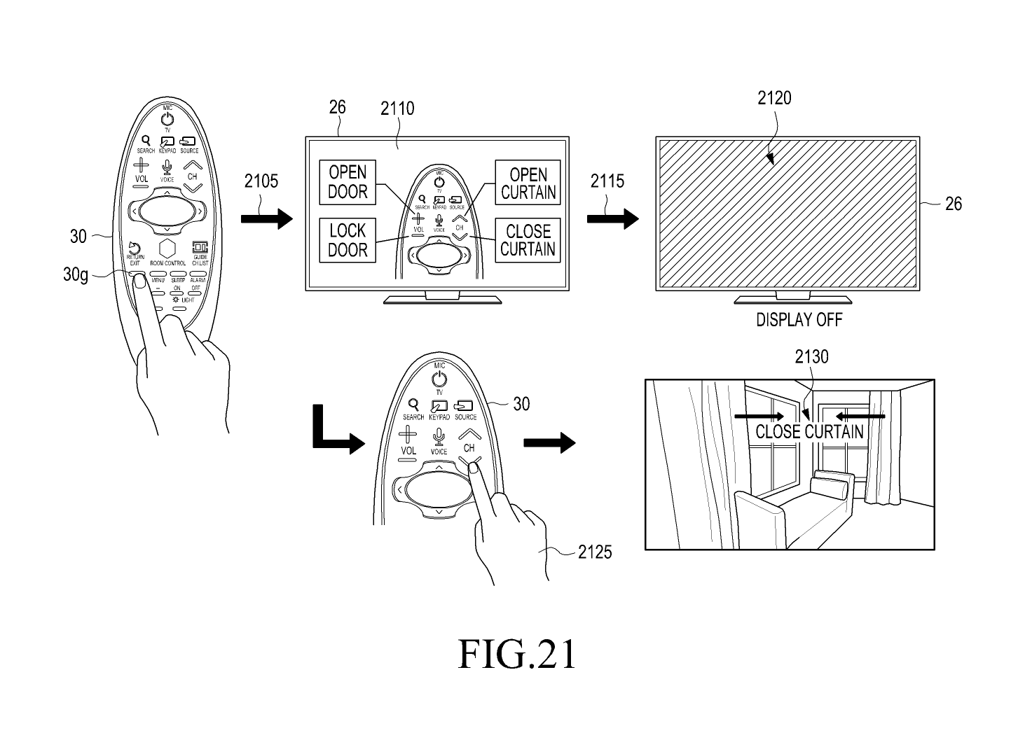

FIG. 21 is a view illustrating a hot key mapping guide according to an embodiment of the present disclosure.

Referring to FIG. 21, the remote controller 30 includes a hot key guide key 30g, and the TV display 26 displays a hot key mapping guide 2110 in response to an input 2105 of the hot key guide key 30g. The hot key mapping guide 2110 may include an image indicating at least a portion of an input unit of the remote controller 30 and a control menu including menu items indicating functions corresponding to at least some keys of the remote controller. In the shown example, the hot key mapping guide 2110 includes menu items (i.e., soft menu keys), such as a [OPEN DOOR] function corresponding to the volume-up key of the remote controller 30, a [LOCK DOOR] function corresponding to the volume-down key, and a [OPEN CURTAIN] and [CLOSE CURTAIN] function corresponding to channel shifting keys. In the example shown, the mapping relation between each key and its corresponding menu item is denoted in a line connecting the key image with the text of the menu item. In an embodiment, the mapping relation may be displayed by placing the key name and the name of its corresponding menu item in parallel. In an embodiment, the mapping relation may be displayed by including the name of the menu item corresponding to the key image in the key image.

The TV display 26 may receive an instruction to output the hot key mapping guide 2110 by the TV function unit 24 or the gateway 22 detecting an input through the remote controller 30. The hot key mapping guide 2110 is mapped with the hot key guide key and includes keys that may be adaptively configured depending on ambient environments, such as the room state, temperature, date, season, or guest profile. The keys provided by the hot key mapping guide 2110 are denoted as guided keys, and the guided keys are operated to perform guided functions only while the hot key mapping guide 2110 remains on the TV display 26.

When receiving no input or guided key input from the remote controller 30 while a predetermined time passes after the hot key mapping guide 2110 has been displayed, the TV display 26 removes the hot key mapping guide 2110, and the keys of the remote controller 30 recover their original functions. After the hot key mapping guide 2110 is removed (2115), the TV display 26 may return to the screen before the hot key mapping guide 2110 is outputted (2120). As an example, the previous screen may be a display-off image or TV image.

When a guided key input is sensed by the remote controller 30 while the hot key mapping guide 2110 is being displayed (2125), the gateway 22 is notified of the key input by the remote controller 30 and performs a function corresponding to the guided key input. When the remote controller 30 detects a key input 2125 for the guided keys, [NEXT CHANNEL] among [VOLUME UP], [VOLUME DOWN], [PREVIOUS CHANNEL], and [NEXT CHANNEL], in the shown example, the gateway 22 receives a key input signal for the key input from the remote controller 30 and instructs the curtain device 2130 to perform the function, [CLOSE CURTAIN], corresponding to [NEXT CHANNEL].

While the guided function is running, the TV display 26 may continue to maintain the hot key mapping guide 2110. The hot key mapping guide 2110 may be maintained until the Exit or Return key is input or a predetermined time (e.g., five seconds) elapses without detecting a key input.

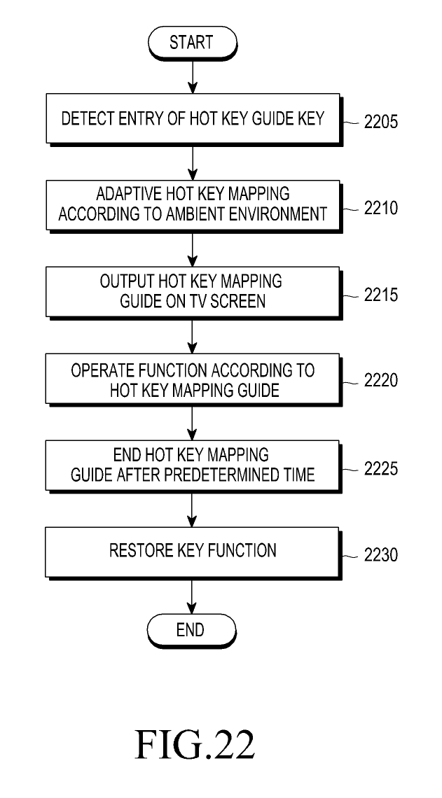

FIG. 22 is an overall flowchart illustrating an example of providing a hot key mapping guide according to an embodiment of the present disclosure.

Referring to FIG. 22, the remote controller 30 detects a user input for a hot key guide key and generates and transmits a key input signal in operation 2205. In operation 2210, the gateway 22 receives the key input signal, and if necessary, adaptively maps hot keys to be included in the hot key mapping guide with their corresponding functions considering the ambient environment. In operation 2215, the gateway 22 generates information regarding the hot key mapping guide indicating the mapped functions and transmits the information to the TV display 26 so that the hot key mapping guide is output on the TV display 26.

In operation 2220, when receiving a user input from the remote controller 30 through one of the guided keys by the hot key mapping guide while the hot key mapping guide is displayed, the gateway 22 controls a corresponding device to perform the function mapped to the guided key. In operation 2225, when detecting no user input or no user input for the guided key through the remote controller 30 or when an END/Cancel key is input, the gateway 22 removes the hot key mapping guide from the TV display 26. In operation 2230, the gateway 22 restores the functions for the keys of the remote controller 30 back to the original ones. After the hot key mapping guide is terminated, the guided keys, [VOLUME UP], [VOLUME DOWN], [PREVIOUS CHANNEL], and [NEXT CHANNEL], are operated to perform their original functions.

According to an embodiment of the present disclosure, hot key mapping may be provided according to an ambient environment, or instead of the ambient environment, according to a direction that the remote controller 30 faces.

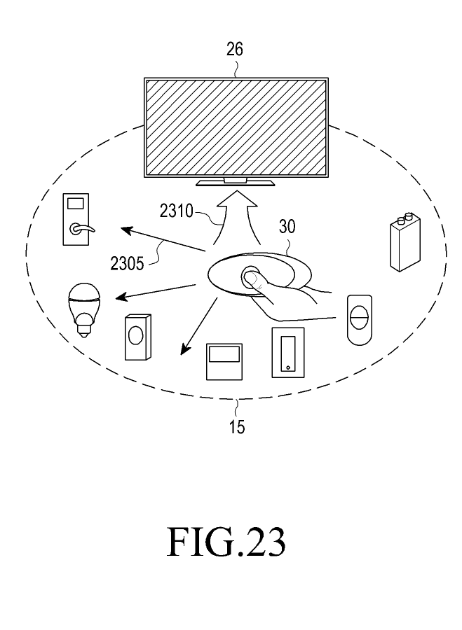

FIG. 23 illustrates an example of providing a hot key mapping guide according to a direction indicated by a remote controller according to an embodiment of the present disclosure.

Referring to FIG. 23, different hot key mapping guides may be provided for when a user input is detected while the remote controller 30 faces the TV display 26 (i.e., the gateway 22) and when a user input is detected while the remote controller 30 faces a device(s) 15 to be controlled through the hot keys. As an example, the remote controller 30 may transmit, to the gateway 22, orientation information 2310 indicating the direction 2305 that the IR transmitter of the remote controller 30 or an upper end of the remote controller 30 faces, and the TV display 26 may output a hot key mapping guide including menu items for controlling the devices located in the direction 2305 that the remote controller 30 faces 2305 under the control of the gateway 22.

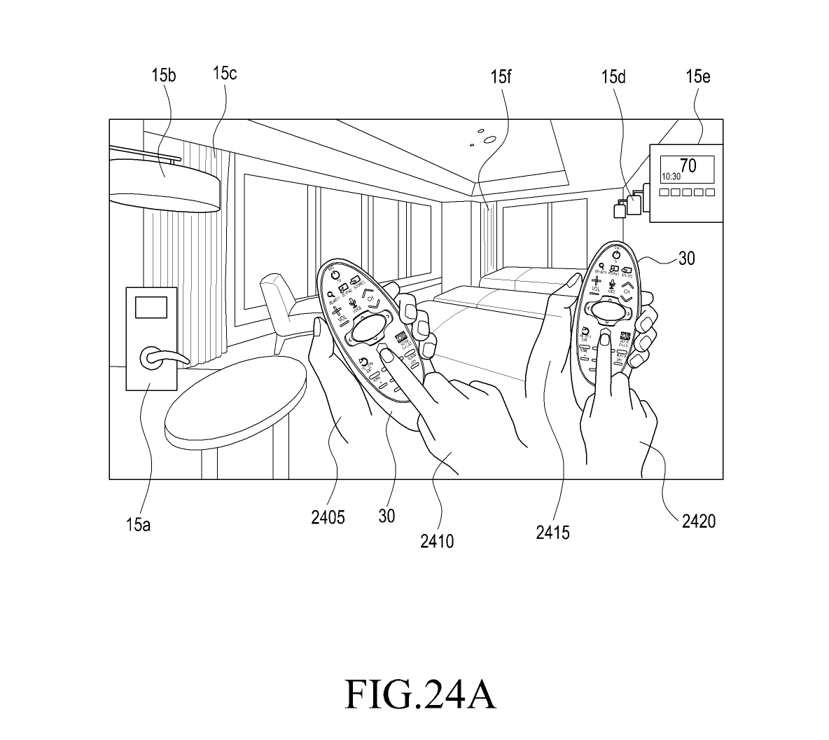

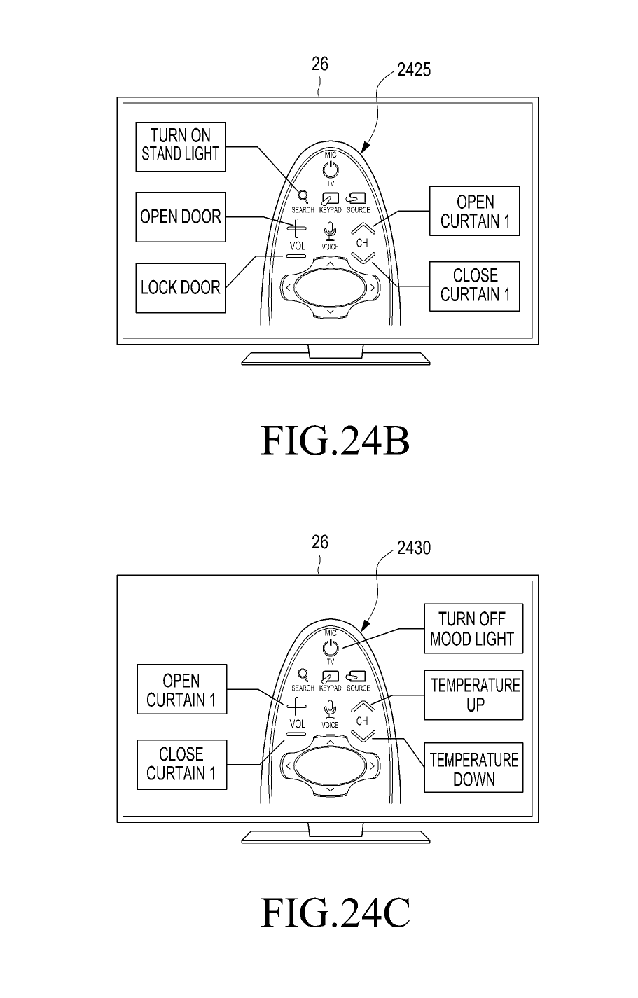

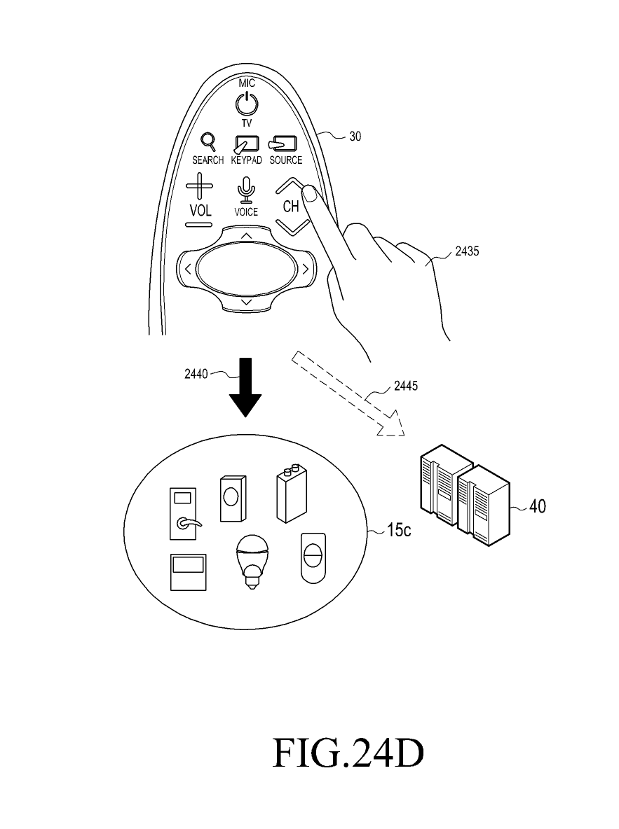

FIGS. 24A to 24D are views illustrating an operational procedure of providing a hot key mapping guide according to a direction indicated by a remote controller according to various embodiments of the present disclosure.

Referring to FIG. 24A, a door lock 15a, a stand light 15b, and a curtain 1 15c are located at a left side 2405 of the remote controller 30. A mood light 15d, a thermostat 15e, and a curtain 2 15f are located at a right side 2415 of the remote controller 30.

When an input 2410 for a hot key guide key is detected while the remote controller 30 faces the left side 2405, the TV display 26 outputs a hot key mapping guide 2425 including a control menu for the devices 15a, 15b, and 15c located at the left side 2405 as shown in FIG. 24B. The hot key mapping guide 2425 includes menu items, [TURN ON STAND LIGHT], [OPEN DOOR], [LOCK DOOR], [OPEN CURTAIN 1], and [CLOSE CURTAIN 1].

When an input 2420 for a hot key guide key is detected while the remote controller 30 faces the right side 2415, the TV display 26 outputs a hot key mapping guide 2430 including a control menu for the devices 15d, 15e, and 15f located at the right side 2415 as shown in FIG. 24C. The hot key mapping guide 2430 includes menu items, [OPEN CURTAIN 2], [CLOSE CURTAIN 2], [TURN OFF MOOD LIGHT], [TEMPERATURE UP], and [TEMPERATURE DOWN].

When detecting a key input corresponding to a guided key while the hot key mapping guide 2425 or 2430 shown in FIG. 24B or 24C is displayed, the gateway 22 transmits a corresponding control command 2440 to a device corresponding to the key input 2425 as shown in FIG. 24D. When the [PREVIOUS CHANNEL] key 2435 is entered through the hot key mapping guide 2425 shown in FIG. 24B, the gateway 22 transmits a control command 2440 to open to the curtain 1 device 15c to perform a [OPEN CURTAIN 1] function corresponding to the [PREVIOUS CHANNEL] key.

When the hot key mapping guide 2425 or 2430 includes a menu item for service request, the gateway 22 may transmit a service request 2445 to the hotel server 40 in response to the input of the menu item as shown in FIG. 24D.

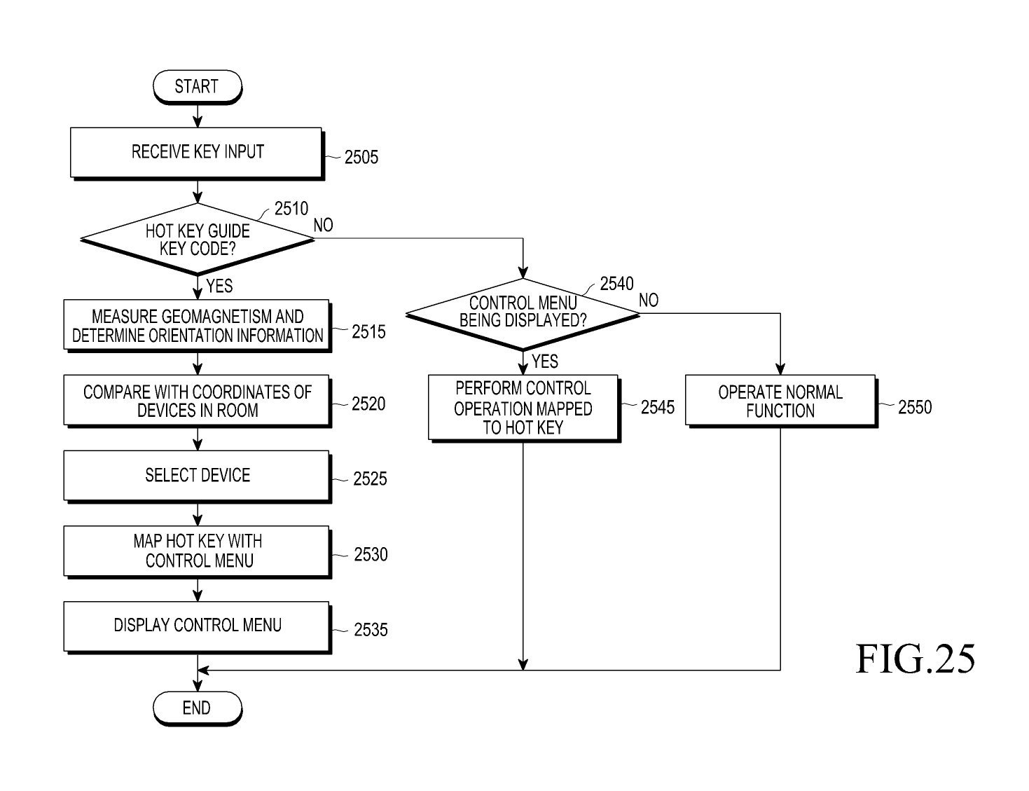

FIG. 25 is a flowchart illustrating an operation of providing an adaptive hot key mapping guide according to an embodiment of the present disclosure. The operation shown may be performed by, e.g., the gateway 22 or the TV function unit 24 that may directly or indirectly receive a key input signal from the remote controller 30.

Referring to FIG. 25, the gateway 22 receives a key input signal corresponding to the key input from the remote controller 30 in operation 2505. The key input signal may include a key code corresponding to the input key and further a geo-magnetic value or orientation information measured by the remote controller 30 at the time of the key input. In operation 2510, the gateway 22 determines whether the key input signal has a key code corresponding to the hot key guide key.

When it is determined that the key code does not correspond to the hot key guide key, the gateway 22 proceeds to operation 2540 to determine whether a control menu provided by the hot key mapping guide is displayed. When the control menu of the hot key mapping guide is displayed, the gateway 22 performs its mapped control function in response to the key input of the guided hot key in operation 2545. By contrast, when the control menu of the hot key mapping guide is not displayed, the gateway 22 performs a normal function corresponding to the key input in operation 2550.

Meanwhile, when it is determined in operation 2510 that the key code corresponds to the hot key guide key, the gateway 22 identifies the orientation information included in the key input signal or determines the orientation information regarding the remote controller 30 based on the geo-magnetic value included in the key input signal in operation 2515. The orientation information may be, e.g., an azimuth on the X-Y coordinates indicating the location and direction of the remote controller 30. As an example, the geo-magnetic value measured by the remote controller 30 has X-Y coordinates and the azimuth is computed by the X-Y coordinates.

In operation 2520, the gateway 22 makes a comparison of the device coordinates indicating the locations of the devices in the room with the orientation information, and in operation 2525, selects at least one device located along the direction that the remote controller 30 faces according to the result of the comparison. In operation 2530, the gateway 22 maps the control menu and hot keys for the selected device, and in operation 2535, the gateway 22 transmits to the TV display 26 information regarding the hot key mapping guide including the control menu and the hot keys for the selected device so that the hot key mapping guide is output on the TV display 26.

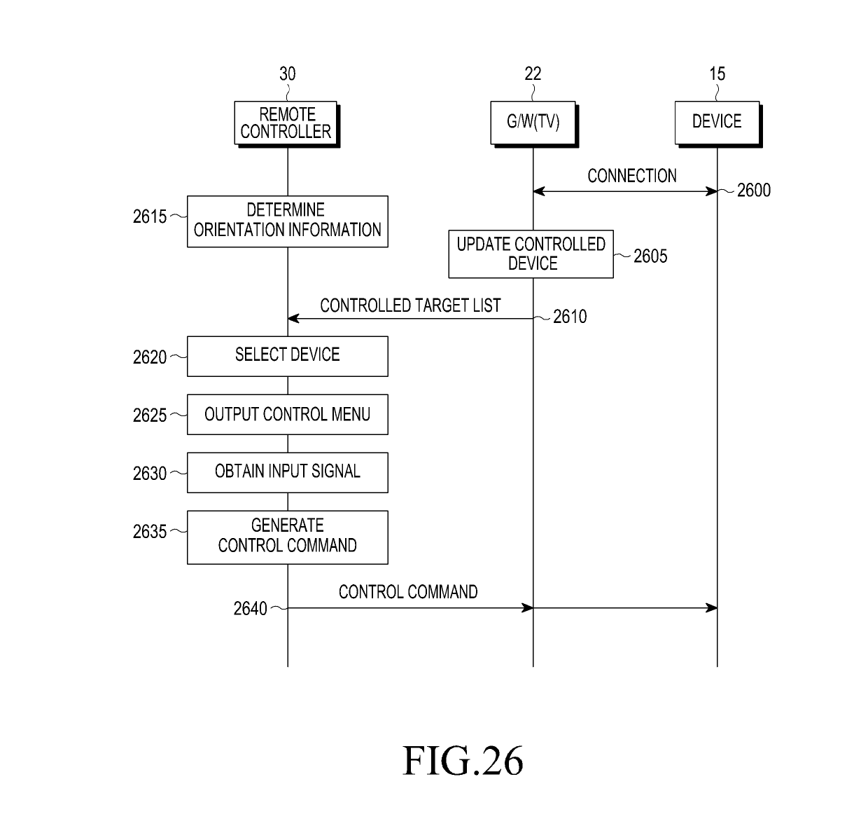

FIG. 26 is a signal flowchart illustrating an example of providing an adaptive hot key mapping guide by a remote controller according to an embodiment of the present disclosure. Here, the network entity processing an input by the remote controller 30 may be the gateway 22, the controller 20, or the TV function unit 24. For ease of description, an example is provided in which the operation is performed by the gateway 22.

Referring to FIG. 26, the gateway 22 establishes a connection with at least one device 15 registered in the smart hotel control system in operation 2600, updates information regarding the device 15 as a controlled device in operation 2605, and transfers a controlled target list including information on controlled devices to the remote controller 30 in operation 2610. Here, the controlled target list may be transferred from the gateway 22 to the remote controller 30 periodically, by an event trigger, or in response to a request from the remote controller 30. As an example, the controlled target list may be updated when a new device is connected or when an existing device is released and may be transferred to the remote controller 30. The controlled target list may include at least one, e.g., the name, model name, manufacturer, function, state, and location, as information regarding each controlled device. In the instant embodiment, the controlled target list includes at least the location of each device.

The following Table 3 represents an example of the controlled target list.

TABLE 3

| Device | Location | Relative location |
|---|---|---|
| Light 1 | 130° SE | Left side (90° E) with respect to curtain 1 |
| Curtain 1 | 180° S | Right side (270° W) with respect to light 1 |
| Thermostat | 50° NE | Right side (90° E) with respect to curtain 2 |

As exemplified in Table 3, the controlled target list contains the name, location information relative to due north, and/or relative location information of each device with respect to another device. The location information may be determined with respect to, e.g., the gateway 22 or the TV function unit 24.

In operation 2615, the remote controller 30 detects a key input by the user and determines orientation information. The orientation information may be, e.g., an azimuth on the X-Y coordinates indicating the direction that the remote controller 30 faces. In operation 2620, the remote controller 30 selects at least one device 15 located along the direction that the remote controller 30 faces based on the controlled target list and the orientation information. In operation 2625, the remote controller 30 outputs through the display a hot key mapping guide including a control menu predetermined for the selected device 15. The control menu provides mapping information regarding the function(s) of the selected device 15 and the user input(s) for performing the function(s). The remote controller 30 may output the hot key mapping guide through its own display. To that end, the remote controller 30 may be configured as, e.g., a smartphone or tablet computer having its own display. In an optional embodiment, the remote controller 30 may transfer information on the hot key mapping guide to the gateway 22 so that the gateway 22 may output the hot key mapping guide through the TV display 26.

In an embodiment, the hot key mapping guide may be provided to the user as a voice while displayed or while not displayed in operation 2625. As an example, the remote controller 30 may output, in a voice, at least one command that may be provided by the selected device and the name of the selected device 15.

The following Table 4 represents an example of the control menu and control signal corresponding to each device.

TABLE 4

| Device | Control menu | | Control signal | |
|---|---|---|---|---|
| Light 1 | Volume up/down key | | On/off | |
| | Motion | Up | Speed/size | Brighter |
| | | Down | | Darker |
| Curtain 1 | Previous/next channel key | | Open/close | |
| | Motion | Left | Speed/size | Move left |
| | | Right | | Move right |

Referring to Table 4, the control menu corresponding to light 1 defines a key code(s) indicating the volume up/down key of the remote controller 30 used to control light 1 and a motion input usable for control of light 1. The control signal corresponding to light 1 includes an on/off signal corresponding to the volume up/down key and a brighter/darker control signal corresponding to an upper/lower-directional motion information. The control menu corresponding to curtain 1 defines a key code(s) indicating the previous/next channel key of the remote controller 30 used to control curtain 1 and a motion input usable for control of curtain 1. The control signal corresponding to curtain 1 includes an open/close signal corresponding to the previous/next channel key and a [MOVE LEFT]/[MOVE RIGHT] control signal corresponding to a left/right-directional motion information.

In an embodiment, a grade or scale by the control signal may be determined depending on the motion speed and/or size of the remote controller 30. As an example, the remote controller 30, when detecting that the remote controller 30 moves in an upper direction, may control light 1 to a brightness corresponding to the speed or degree of the upper-directional movement. As an example, when the speed or degree (i.e., moved distance) of the upper-directional movement exceeds a predetermined threshold, a control signal is output to instruct to adjust light 1 to a brightness of 90%. As another example, when detecting that the remote controller 30 moves leftward, the remote controller 30 sends out a control signal to instruct curtain 1 to continue to move in the left direction, and when the remote controller 30 stops moving, the remote controller 30 sends out a control signal to instruct to stop the control of curtain 1. As an example, when the speed of the left-directional movement of the remote controller 30 exceeds a second threshold, the remote controller 30 may send out a control signal to instruct to open curtain 1 to the left by 80%.

When detecting one of the user inputs guided by the hot key mapping guide in operation 2630, the remote controller 30 generates a control command indicating a function corresponding to the user input in operation 2635. As an example, the user input may include at least one of a key input, a motion input, and a touch input for at least one key guided by the hot key mapping guide among the keys of the remote controller 30. In operation 2640, the control command is transmitted to the device 15 that may perform the function corresponding to the key input directly or via the TV function unit 24 or the gateway 22.

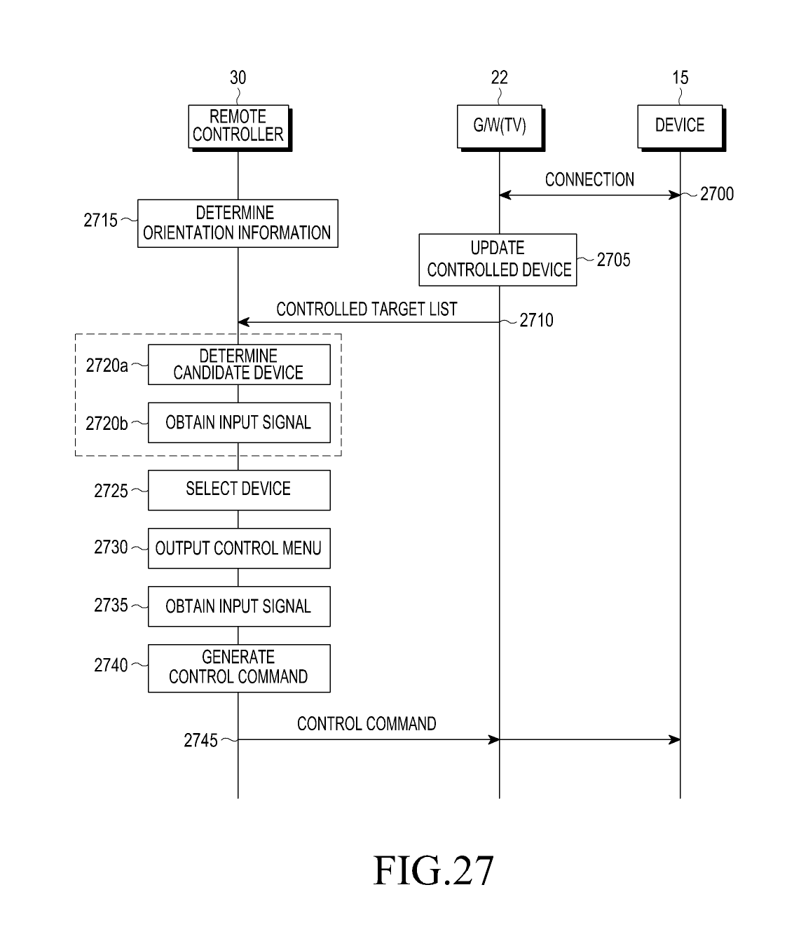

FIG. 27 is a signal flowchart illustrating an example of providing an adaptive hot key mapping guide when a plurality of devices are oriented in the same direction according to an embodiment of the present disclosure. Here, the gateway 22 processing an input by the remote controller 30 may be replaced with the TV function unit 24 or the controller 20.

Referring to FIG. 27, the gateway 22 establishes a connection with at least one device 15 registered in the smart hotel control system in operation 2700, updates information regarding the device 15 as a controlled device in operation 2705, and transfers a controlled target list including information on controlled devices to the remote controller 30 in operation 2710. Here, the controlled target list may be transferred from the gateway 22 to the remote controller 30 periodically, by an event trigger, or in response to a request from the remote controller 30. As an example, the controlled target list may be updated when a new device is connected or when an existing device is released and may be transferred to the remote controller 30. The controlled target list may include at least one of, e.g., the name, model name, manufacturer, function, state, and location, as information regarding each controlled device. In the instant embodiment, the controlled target list includes at least the location of each controlled device.

In operation 2715, the remote controller 30 detects a user input and determines orientation information. The orientation information may be, e.g., a geo-magnetic value measured by the remote controller 30 or an azimuth on the X-Y coordinates indicating the direction that the remote controller 30 faces. In operation 2720a, the remote controller 30 identifies a plurality of candidate devices located along the direction that the remote controller 30 faces based on the controlled target list and the orientation information and provides information regarding the candidate devices to the user through the display or voice. As an example, the candidate devices may be devices included in the controlled target list. As an example, the display of the remote controller 30 may output mapping information of user inputs (e.g., at least one of a key input, a motion input, a touch input, and a voice input) mapped to the candidate devices and symbols (e.g., small pictures) of the plurality of candidate devices.

As an example, the remote controller 30 may transfer the information on the plurality of candidate devices to the gateway 22 so that the gateway 22 may output a selection menu to select the candidate devices through the TV display 26. As an example, the selection menu may include mapping information of user inputs (e.g., at least one of a key input, a motion input, a touch input, and a voice input) mapped to the candidate devices and symbols of the candidate devices. As another example, the remote controller 30 may output a list of candidate devices in a voice.

In operation 2720b, the remote controller 30 detects a user input to select a controlled device among the candidate devices, and in operation 2725, selects the device 15 corresponding to the user input. The user input may be an input for a key of the remote controller 30 corresponding to one of the candidate devices, for example. As an example, the user input may be a motion input or voice input indicating one of the candidate devices.

In operation 2730, the remote controller 30 outputs, through the display, a hot key mapping guide including a control menu predetermined for the selected device 15. The control menu provides mapping for a function(s) of the selected device 15 and a key of the remote controller 30 to perform the function(s). The remote controller 30 may output the hot key mapping guide through its own display. To that end, the remote controller 30 may be configured as, e.g., a smartphone or tablet computer having its own display. In an optional embodiment, the remote controller 30 may transfer information on the hot key mapping guide to the gateway 22 so that the gateway 22 may output the hot key mapping guide through the TV display 26.

When detecting one of the user inputs guided by the hot key mapping guide in operation 2735, the remote controller 30 generates a control command indicating a function corresponding to the user input in operation 2740. In operation 2745, the control command is transmitted to the device 15 that may perform the function corresponding to the user input directly or via the TV function unit 24 or the gateway 22.

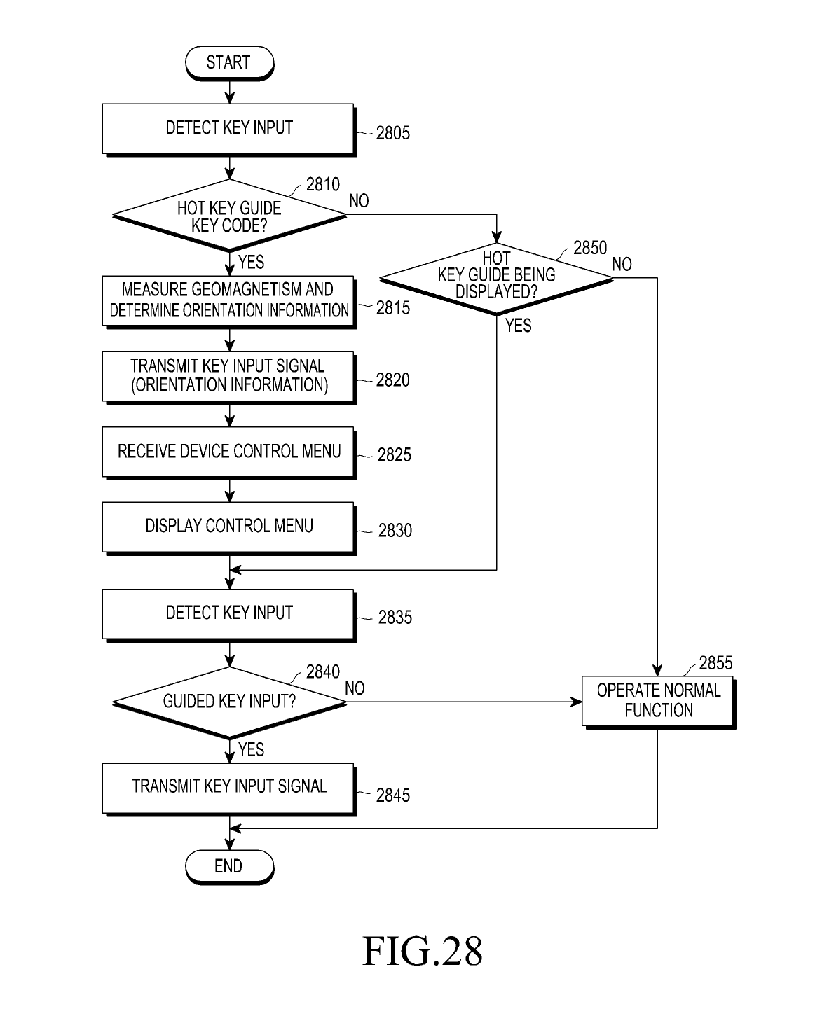

FIG. 28 is a flowchart illustrating an operation by a remote controller to provide a hot key mapping guide according to an embodiment of the present disclosure.

Referring to FIG. 28, the remote controller 30 detects a key input by the user and determines a code corresponding to the key input in operation 2805. In operation 2810, the remote controller 30 determines whether the determined code is a key code corresponding to a hot key guide key. When the determined code is not the key code of the hot key guide key, the gateway 30 proceeds to operation 2850 to determine whether a control menu provided by the hot key mapping guide is displayed. When the control menu of the hot key mapping guide is displayed, the remote controller 30 proceeds to operation 2835. By contrast, when the control menu of the hot key mapping guide is not displayed, the remote controller 30 performs a normal function corresponding to the key input in operation 2855.

Meanwhile, when it is determined in operation 2810 that the key code corresponds to the hot key guide key, the remote controller 30 measures a geo-magnetic value to determine orientation information in operation 2815. The orientation information may be, e.g., an azimuth indicating the direction that the remote controller 30 faces. As another example, the orientation information may be the geo-magnetic value measured.

In operation 2820, the remote controller 30 transmits a key input signal including the orientation information to the gateway 22. The remote controller 30 receives, from the gateway 22, information on the hot key mapping guide including the control menu mapped to at least one controlled device in operation 2825 and displays the hot key mapping guide in operation 2830. The control menu may provide mapping for a function(s) of the controlled device and a key(s) of the remote controller 30 to perform the function(s).

The remote controller 30 detects a key input in operation 2835 and determines whether the detected key input is a key input corresponding to one of the keys guided by the hot key mapping guide in operation 2840. When the detected key input is not the guided key input, the remote controller 30 performs a normal function corresponding to the key input in operation 2855. By contrast, when detecting the guided key input, the remote controller 30 transmits the key input signal indicating the key input in operation 2845 to the gateway 22 so that the gateway 22 transmits a control command indicating the function corresponding to the key input to the controlled device.

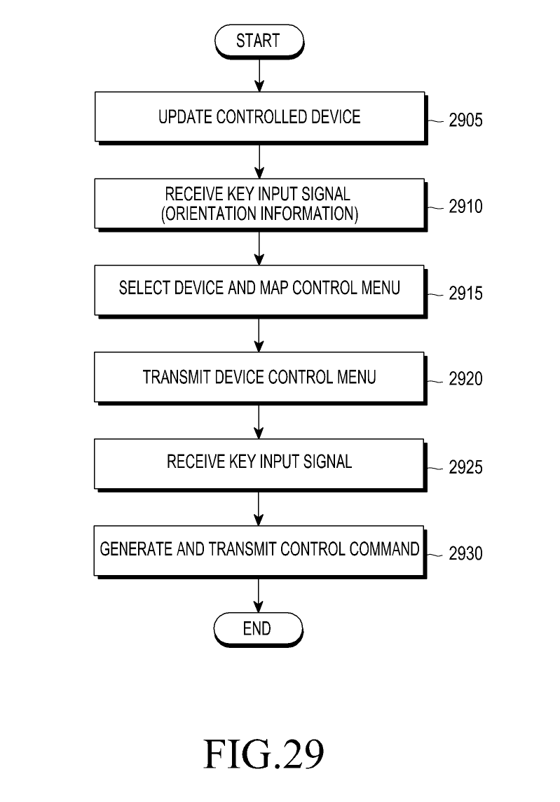

FIG. 29 is a flowchart illustrating an operation by a gateway to provide a hot key mapping guide according to an embodiment of the present disclosure. Here, the gateway 22 processing an input by the remote controller 30 may be replaced with the TV function unit 24 or the controller 20.

Referring to FIG. 29, the gateway 22 updates the controlled target list including information on controlled devices whenever a device is registered, released, or varied in the smart hotel control system in operation 2905. In operation 2910, the gateway 22 receives a key input signal including orientation information from the remote controller 30. In operation 2915, the gateway 22 selects at least one controlled device located along the direction that the remote controller 30 faces based on the orientation information and the controlled target list and maps a predetermined control menu to the selected device. In operation 2920, the gateway 22 transmits to the remote controller 30 information on a hot key mapping guide including the control menu mapped to the selected device. The gateway 22 receives from the remote controller 30 a key input signal for one of keys guided by the hot key mapping guide in operation 2925 and transmits a control command indicating a function corresponding to the key input signal to a corresponding controlled device in operation 2930.

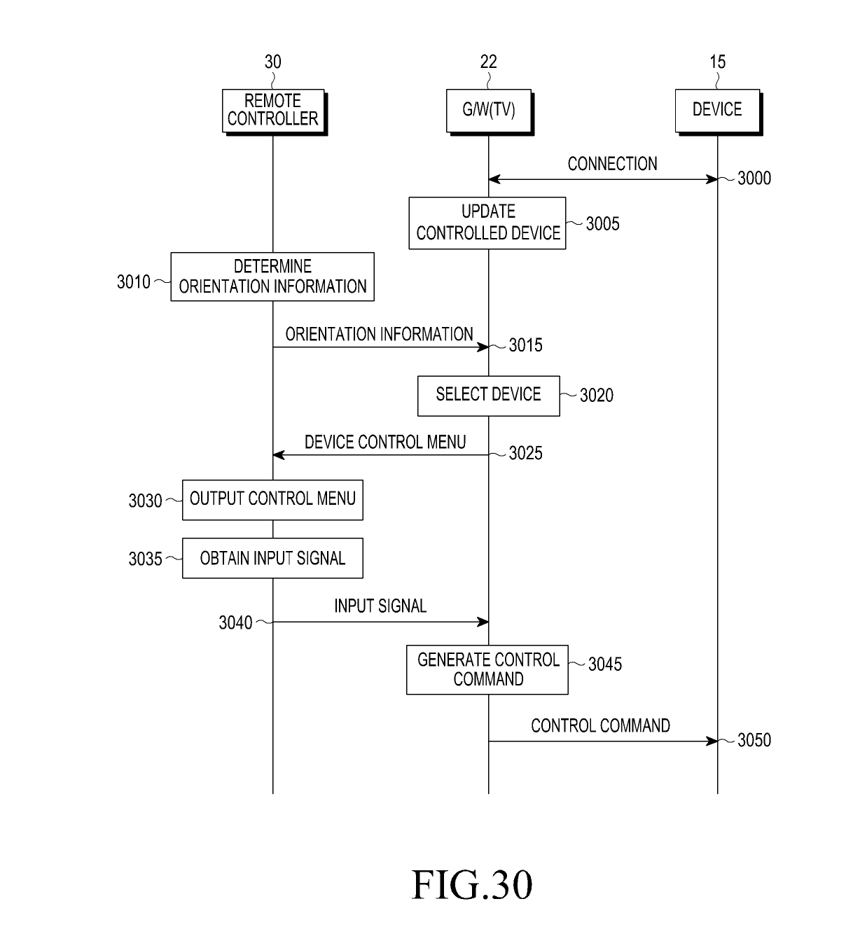

FIG. 30 is a signal flowchart illustrating an example of controlling a device corresponding to orientation information by a gateway according to an embodiment of the present disclosure. Here, the gateway 22 processing an input by the remote controller 30 may be replaced with the TV function unit 24 or the controller 20.

Referring to FIG. 30, the gateway 22 establishes a connection with at least one device 15 registered in the smart hotel control system in operation 3000 and updates information regarding the device 15 as a controlled device in operation 3005 to thereby configure a controlled target list.

In operation 3010, the remote controller 30 detects a key input by the user and determines orientation information. The orientation information may be, e.g., a geo-magnetic value measured by the remote controller 30 or an azimuth indicating the direction that the remote controller 30 faces. In operation 3015, the remote controller 30 carries the orientation information over a key input signal to the gateway 22. The key input signal may contain the orientation information and a key code corresponding to the detected key input.

In operation 3020, the gateway 22 compares the orientation information with a location for the controlled device in the controlled target list to select at least one controlled device located along the direction that the remote controller 30 faces based on the orientation information and the controlled target list and maps a predetermined control menu to the selected device. In operation 3025, the gateway 22 transmits to the remote controller 30 information on a hot key mapping guide including the control menu mapped to the selected device. In operation 3030, the remote controller 30 displays a control menu included in the hot key mapping guide.

In operation 3035, the remote controller 30 detects a key input corresponding to one of the keys guided by the hot key mapping guide, and in operation 3040, transmits the key input signal corresponding to the detected key input to the gateway 22. In operation 3045, the gateway 22 generates a control command indicating a function corresponding to the key input, and in operation 3050, transmits the control command to a corresponding controlled device.

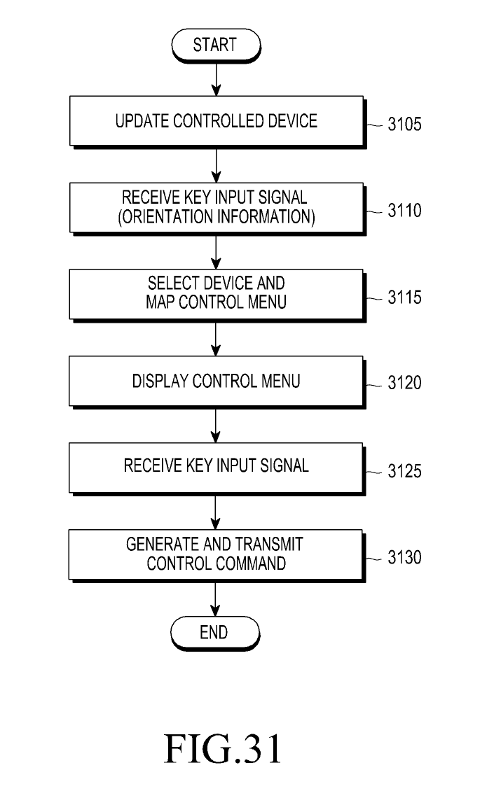

FIG. 31 is a flowchart illustrating an operation by a gateway displaying a control menu of a hot key mapping guide according to an embodiment of the present disclosure. Here, the gateway 22 processing an input by the remote controller 30 may be replaced with the TV function unit 24 or the controller 20.

Referring to FIG. 31, the gateway 22 updates the controlled target list including information on controlled devices whenever a device is registered, released, or varied in the smart hotel control system in operation 3105. When receiving a key input signal including orientation information from the remote controller 30 in operation 3110, the gateway 22 selects at least one controlled device located along the direction that the remote controller 30 faces based on the orientation information and the controlled target list and maps a control menu including a predetermined function to the selected device in operation 3115.

In operation 3120, the gateway 22 displays the hot key mapping guide including the control menu to the TV display 26. The gateway 22 receives from the remote controller 30 a key input signal for one of keys guided by the hot key mapping guide in operation 3125 and generates and transmits a control command indicating a function corresponding to the key input signal to a corresponding controlled device in operation 3130.

Although an embodiment in which a remote controller interworking with a TV has a hot key guide key has been described thus far, a dedicated remote controller having hot keys may be used to more efficiently control the smart hotel.

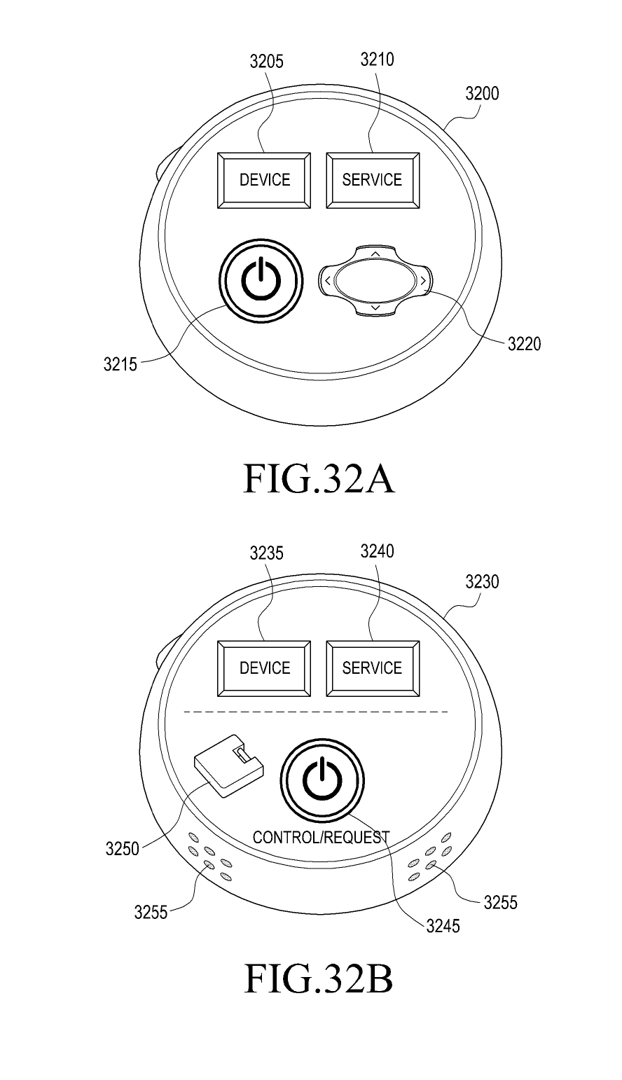

FIGS. 32A and 32B illustrate input units of hot key-dedicated remote controllers according to various embodiments of the present disclosure.

Referring to FIG. 32A, the remote controller 3200 includes a device key 3205, a service key 3210, a binary control key 3215, and a multiple control key 3220. The device key 3205 is used to select a device to be controlled (i.e., a controlled device), and the service key 3210 is used to select a service to be requested. The binary control key 3215 is selected to power on/off or lock/unlock the selected controlled device or to request (set)/cancel a service selected by the service key 3210, and the multiple control key 3220 is used to control the temperature of the controlled device, the brightness of light, the degree of opening/closing curtain with a grade value, etc.

Referring to FIG. 32B, the remote controller 3230 includes a device key 3235, a service key 3240, and a control/request key 3245 and may further include a sensor unit 3250 and a speaker 3255 to be able to control the controlled device according to a combination of a key input and a motion input. The sensor unit 3250 may be configured as an acceleration/gyro/geo-magnetic sensor. The device key 3235 is used to select a device to be controlled (i.e., a controlled device), and the service key 3240 is used to select a service to be requested. The control/request key 3245 is used to power on/off or lock/unlock the controlled device or to request (set)/cancel a service selected by the service key 3210.

The remote controller 3230, when the device key 3235 is entered, transfers a list of candidate devices, which may be controlled devices, to the user through the TV display 26 or the speaker 3255. As an example, the TV display 26 may output images (pictures) of devices located in the direction that the remote controller 3230 faces in response to the entry of the device key 3235. As an example, the remote controller 3230 may output the name of the device located in the direction that the remote controller 3230 faces in a voice (sound) in response to the entry of the device key 3235. The devices located in the direction that the remote controller 3230 faces are determined based on a geo-magnetic value measured by the sensor unit 3250 and a controlled target list configured by the gateway 22. The remote controller 3230 may determine a function to be performed by the controlled device in response to a motion sensed by the sensor unit 3250.

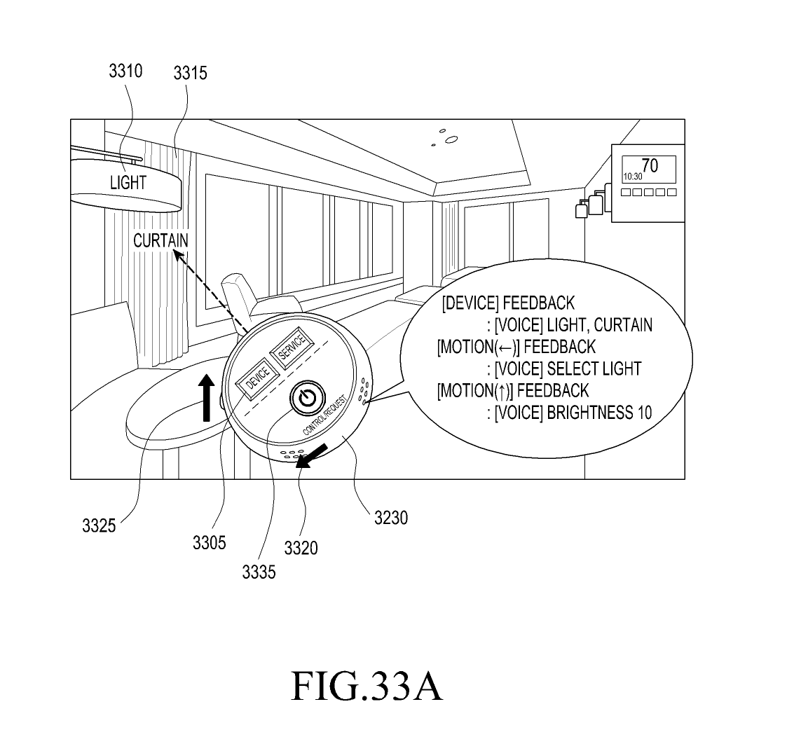

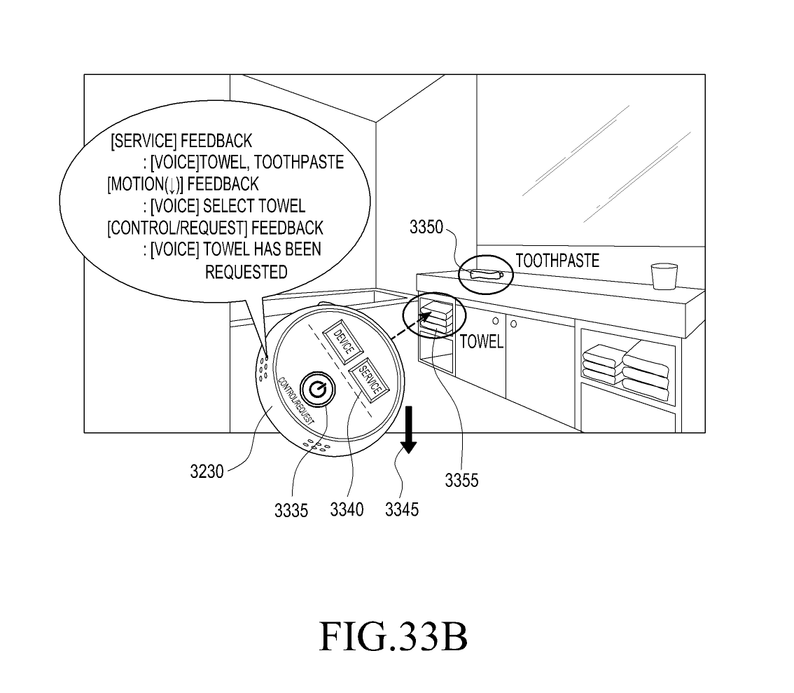

FIGS. 33A and 33B are views illustrating examples of using a hot key-dedicated remote controller according to various embodiments of the present disclosure.

FIG. 33A illustrates an example of an operation of adjusting the brightness of a light when multiple devices are present in the room. Referring to FIG. 33A, when detecting that the device key 3305 is pressed while the remote controller 3230 faces a light 3310, which is supposed to be controlled by the remote controller 3230, the remote controller 3230 outputs, in a voice through the speaker, a description of devices 3310 and 3315, “light, curtain,” located in the direction corresponding to the orientation information among the devices in the controlled target list. While the plurality of devices 3310 and 3315 are detected, the remote controller 3230 may determine the controlled device in response to a motion input.

In a specific example, when detecting a left-directional motion 3320 while the device key 3305 remains pressed, the remote controller 3230 outputs “Light selected” in a voice to notify the user that the light has been selected. Although not shown, when detecting a right-directional motion while the device key 3305 remains pressed, the remote controller 3230 may output “Curtain selected” in a voice. When the device key 3305 is released from being pressed, the remote controller 3230 determines a device finally selected, the light in the illustrated example, as the controlled device.

When detecting that the control/request key 3335 is pressed while the light is selected, the remote controller 3230 waits for a motion input to control the function of the light. When detecting an upper-directional motion 3325 while the control/request key 3335 remains pressed, the remote controller 3230 outputs a brightness corresponding to the size of the motion, e.g., “brightness 10,” in a voice, and the light 3310 is controlled with brightness 10. When the control/request key 3335 is released from being pressed while the particular brightness is selected, the light 3310 maintains the brightness controlled by the remote controller 3230.

FIG. 33B illustrates an example of an operation of requesting a towel while multiple supplies are present in the room. Referring to FIG. 33B, when detecting the pressing of the service key 3340 while the remote controller 3230 faces a towel 3355, which is supposed to be controlled by the remote controller 3230, the remote controller 3230 outputs, in a voice through the speaker, supplies for service, “towel” and “toothpaste,” located in the direction corresponding to the orientation information. While the plurality of supplies 3350 and 3355 are detected, the remote controller 3230 may determine the supply for service in response to a motion input.

In an example, when detecting a lower-directional motion 3345 while the service key 3340 remains pressed, the remote controller 3230 outputs “Towel selected” in a voice to notify the user that the towel has been selected. Although not shown, when detecting an upper- or right-directional motion while the service key 3340 remains pressed, the remote controller 3230 may output “Toothpaste selected” in a voice. When the service key 3340 is released from being pressed, the remote controller 3230 determines a supply finally selected, the towel in the illustrated example, as the supply for service.

When detecting that the control/request key 3335 is pressed while the towel is selected, the remote controller 3230 may output “Towel has been requested” in a voice and may send a service request signal for “request towel” to the gateway 22 so that the gateway 22 may request the hotel server 40 to add more towels.

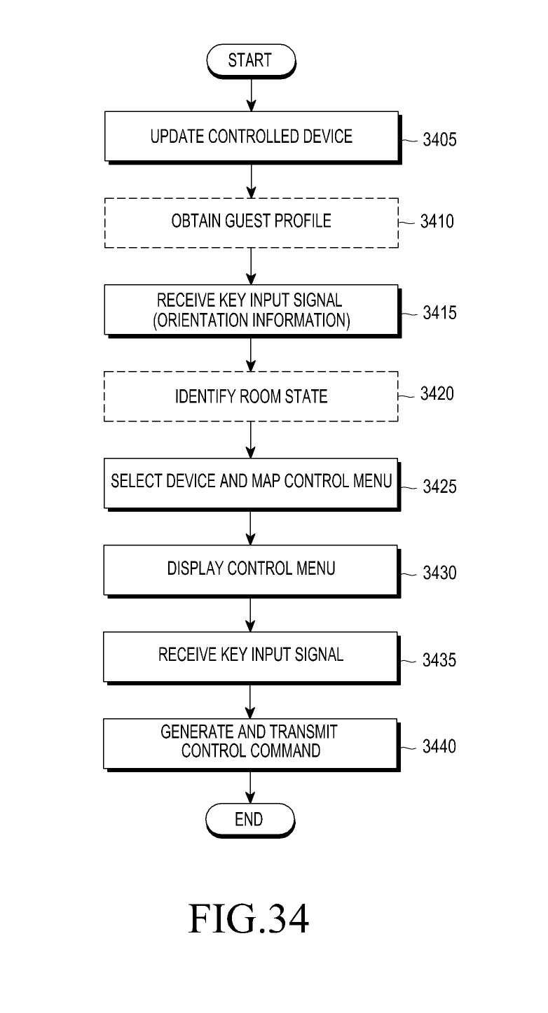

FIG. 34 is a flowchart illustrating an operation of providing a hot key mapping guide considering a room situation according to an embodiment of the present disclosure. Here, the network entity processing an input by the remote controller 30 may be the gateway 22, the controller 20, or the TV function unit 24. For ease of description, an example is provided in which the operation is performed by the gateway 22. Further, the remote controller 30 may be replaced with the remote controller 3200 shown in FIG. 32A or the remote controller 3230 shown in FIG. 32B.

Referring to FIG. 34, the gateway 22 updates the controlled target list including information on controlled devices whenever a device is registered, released, or varied in the smart hotel control system in operation 3405. In an optional operation 3410, the gateway 22 obtains a guest profile from the hotel server 40. The guest profile may include at least one of the gender or age of the guest, whether to accompany infants, and a previous history. Here, the previous history may include functions frequently used during the guest's previous accommodation.

When receiving a key input signal including orientation information from the remote controller 30 in operation 3415, the gateway 22 identifies the room state, such as room mode, time, season, or guest state, in an optional operation 3420. The guest state may include at least one of, e.g., check-in, state of sleeping, state of using the bathroom, or watching TV.

In operation 3425, the gateway 22 selects at least one controlled device located in the direction that the remote controller 30 faces based on at least one of the orientation information, the controlled target list, the guest profile, and the room state and maps a predetermined control menu to the selected device.

In operation 3430, the gateway 22 displays a hot key mapping guide including the control menu through the TV display 26 or the display of the remote controller 30. The gateway 22 receives from the remote controller 30 a key input signal for a key guided by the hot key mapping guide in operation 3435 and transmits a control command indicating a function corresponding to the key input signal to a corresponding controlled device in operation 3440.

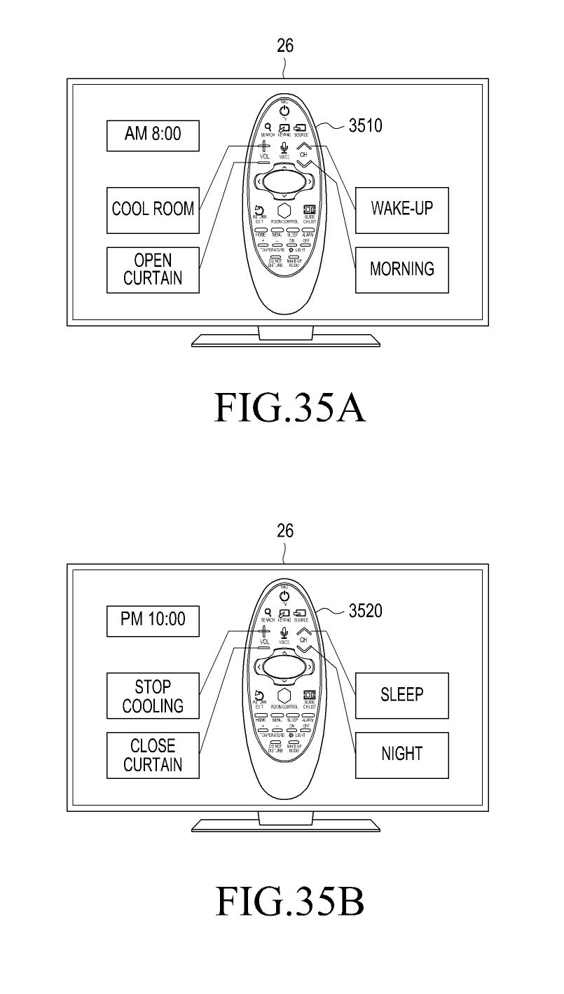

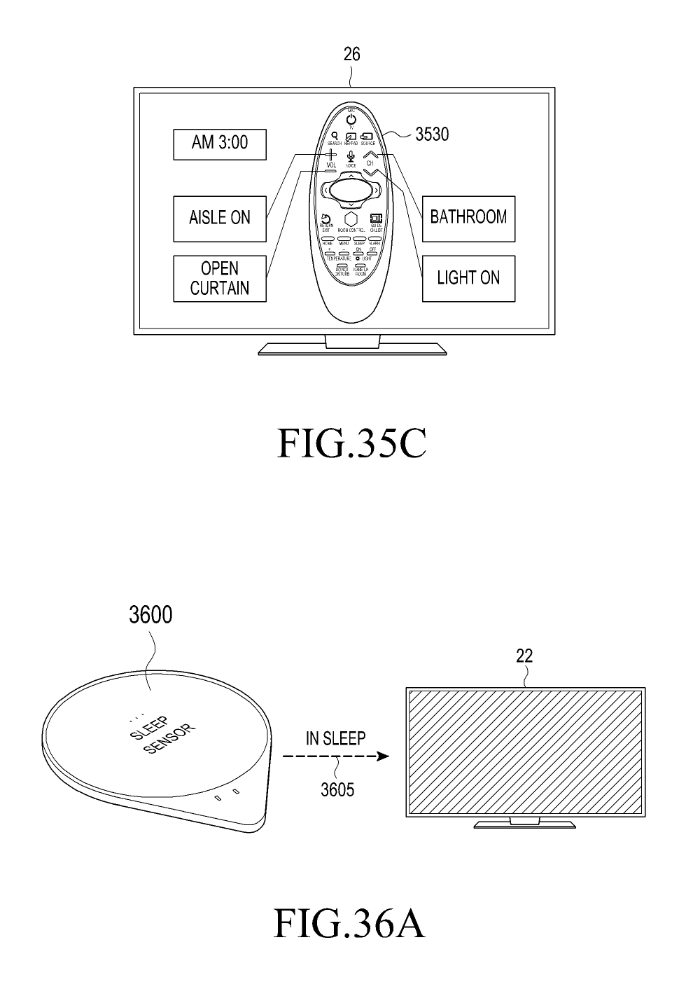

FIGS. 35A to 35C are views illustrating examples of providing an adaptive hot key guide according to time according to various embodiments of the present disclosure.

FIG. 35A illustrates a hot key mapping guide 3510 that may be provided through the display of the remote controller 30 or the TV display 26 in response to entry of a hot key guide key at 8:00 AM. As illustrated, the hot key mapping guide 3510 includes device control items, such as [COOL ROOM] and [OPEN CURTAIN], and service request items, such as [WAKE-UP] and [MORNING], which are respectively mapped to particular keys of the remote controller 30. As an example, the device control items may be mapped to the volume-up/down keys, and the service request items may be mapped to the previous/next channel keys.

FIG. 35B illustrates a hot key mapping guide 3520 that may be provided in response to entry of a hot key guide key at 10:00 PM. As illustrated, the hot key mapping guide 3520 includes service request items, such as [STOP COOLING], [CLOSE CURTAIN], [SLEEP], and [NIGHT], which are highly likely to be used to prepare to sleep. As an example, [STOP COOLING] and [CLOSE CURTAIN] may be mapped to the volume up/down keys, and [SLEEP] and [NIGHT] for preparing to control sleep and night time may be mapped to the previous/next channel keys.

FIG. 35C illustrates a hot key mapping guide 3530 that may be provided in response to entry of a hot key guide key at 3:00 AM. As illustrated, the hot key mapping guide 3530 includes device control items, such as [COOLER ON], [OPEN CURTAIN], [BATHROOM ON], and [LIGHT ON], which are highly likely to be used during sleep. As an example, [COOLER ON] and [OPEN CURTAIN] may be mapped to the volume up/down keys, and [BATHROOM ON] and [LIGHT ON] may be mapped to the previous/next channel keys. Specifically, the [LIGHT ON] function to turn on the light located toward the bathroom is configured with higher priority in the early morning time zone.

Additionally, the hot key mapping guide may include proper functions depending on seasons. As an example, the hot key mapping guide may include device control items to operate a heating function in the winter, and the hot key mapping guide may include device control items to operate a cooling function in the summer.

In an embodiment, the hot key mapping guide may be adaptively configured depending on the guest profile. As an example, when the guest is in an older age group, the hot key mapping guide may be configured in a silver mode with a larger font size, more simplified functions, and oriented to group control. The silver-mode hot key mapping guide may include fewer menu items than those of the normal-mode hot key mapping guide, and each menu item may be configured to perform control on a per-group basis rather than on an individual basis. As an example, the silver-mode hot key mapping guide may be configured with keys mapped to [SLEEP] and [WAKE-UP], and in response to a guided key input of [SLEEP], relevant functions, such as stop cooling, close curtain, and notify hotel server of sleep, may be simultaneously performed.

In an embodiment, the hot key mapping guide may be adaptively configured by reflecting the user's state grasped in an active manner as well as the time and season. As an example, a sleep sensor that may be located under the bed head or the pillow may detect whether the user is in sleep, and when detecting that the user is in sleep, the hot key mapping guide may be configured to include functions corresponding thereto.

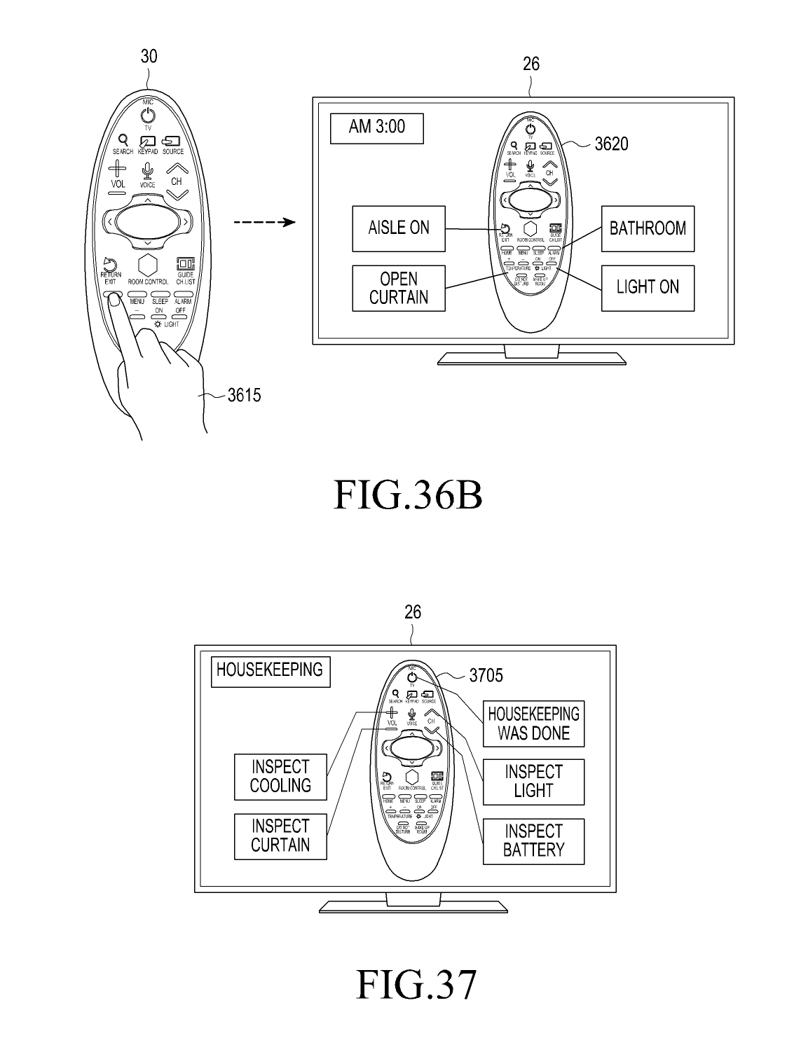

FIGS. 36A and 36B are views illustrating examples of providing a hot key mapping guide reflecting a user's state according to various embodiments of the present disclosure.

Referring to FIGS. 36A and 36B, a sleep sensor 3600 is positioned under the head of a bed or a pillow to periodically detect whether the user is asleep and notifies the gateway 22 of the result (3605). When receiving a key input signal for the hot key guide key from the remote controller 30 under the situation of recognizing that the user is in sleep (3615), the gateway 22 displays a hot key mapping guide 3620 corresponding to the sleep status on the TV display 26. The hot key mapping guide 3620 corresponding to the sleep status may include menu items, such as, e.g., [COOLER ON], [OPEN CURTAIN], [BATHROOM ON], and [LIGHT ON].

In an embodiment, the hot key mapping guide may be adaptively configured depending on the room mode. As an example, when a housekeeper comes into the room, the room mode turns to a housekeeping status. Upon detecting an input for the hot key guide key while the room mode is in the housekeeping status, the hot key mapping guide may be configured to include functions for the housekeeper. As an example, the hot key mapping guide may be adaptively configured according to various room modes, i.e., the guest mode and inspector mode.

FIG. 37 is a view illustrating an example of providing an adaptive hot key mapping guide according to a room mode according to an embodiment of the present disclosure.

Referring to FIG. 37, when the housekeeper comes in the room using her master key, the gateway 22 receives a notification for the housekeeper's entry from the door lock and changes the room mode into the housekeeping status. When receiving a key input signal corresponding to the hot key guide key from the remote controller 30 in the housekeeping status, the gateway 22 displays a hot key mapping guide 3705 including functions for inspecting device and cleaning on the TV display 26. The hot key mapping guide 3705 for the housekeeping status may include device control items, e.g., [INSPECT COOLING], [INSPECT CURTAIN], [INSPECT LIGHT], and [INSPECT BATTERY], and a service request item, e.g., [CLEANING DONE].

In an embodiment, the hot key mapping guide may include menu items arranged in order of higher use frequency depending on room statistical information.

Although various environmental factors, such as a guest's age, time, season, and use frequency, to adaptively configure a hot key mapping guide have been described thus far, a hot key mapping guide may also be configured by combining at least one of the environmental factors. As an example, the hot key mapping guide may be configured to include functions with higher use frequency corresponding to the age group where the guest belongs, time, and season.

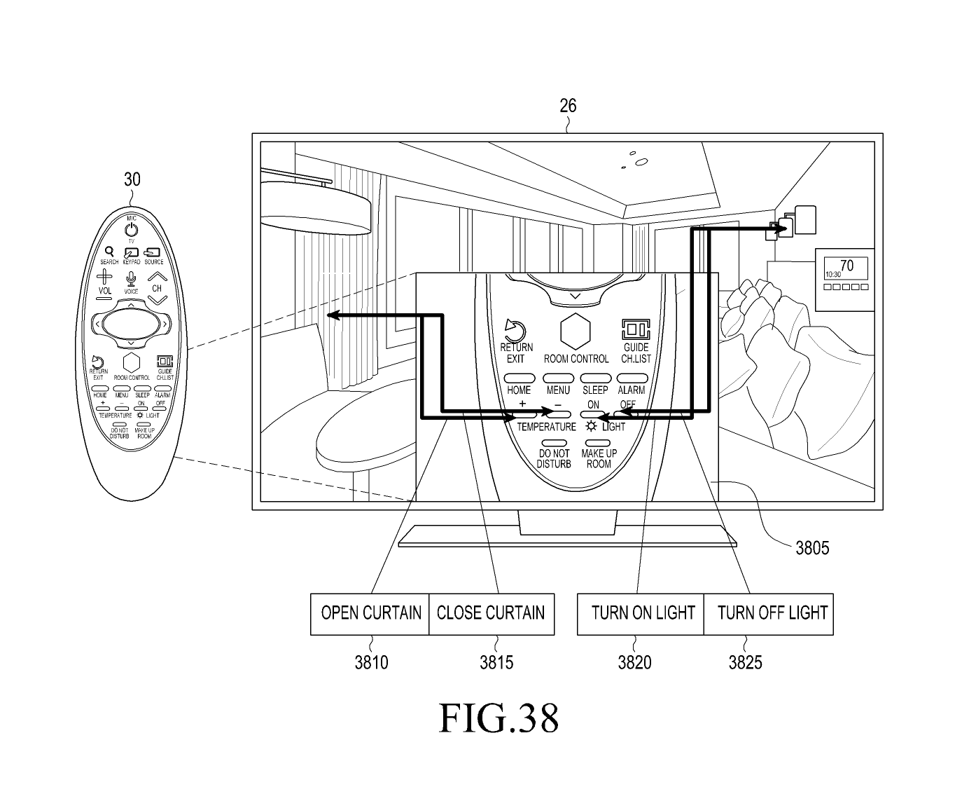

FIG. 38 is a view illustrating a hot key mapping guide configured according to a hot key use history according to an embodiment of the present disclosure.

Referring to FIG. 38, a key input signal for a hot key guide key is received from the remote controller 30, and the hot key mapping guide 3805 to be displayed on the TV display 26 in response to the reception of the key input signal may be configured according to a previous hot key use history. As an example, the menu items 3810, 3815, 3820, and 3825 included in the hot key mapping guide 3805 may run a predetermined number of functions with a higher use frequency. In the example illustrated, the functions with a higher use frequency include [OPEN CURTAIN] 3810, [CLOSE CURTAIN] 3815, [LIGHT ON] 3820, and [LIGHT OFF] 3825, and the functions 3810, 3815, 3820, and 3825 are respectively mapped to [TEMPERATURE: +], [TEMPERATURE: −], [LIGHT ON], and [LIGHT OFF].

In an embodiment, the menu items 3810, 3815, 3820, and 3825 included in the hot key mapping guide 3805 may indicate frequently used functions in the corresponding room regardless of the guest profile. In an embodiment, the menu items 3810, 3815, 3820, and 3825 included in the hot key mapping guide 3805 may indicate the functions frequently used by the current guest in the past considering the guest profile.

The menu items 3810, 3815, 3820, and 3825 may be configured with an image resembling a real-life input unit of the remote controller 30, the name of the function corresponding to each hot key symbol on the input unit, and lines connecting the hot keys with the names. As such, the hot key on the remote controller 30 corresponding to the function desired by the user may be intuitively recognized by displaying the name of each function and hot key symbols and lines connecting them.

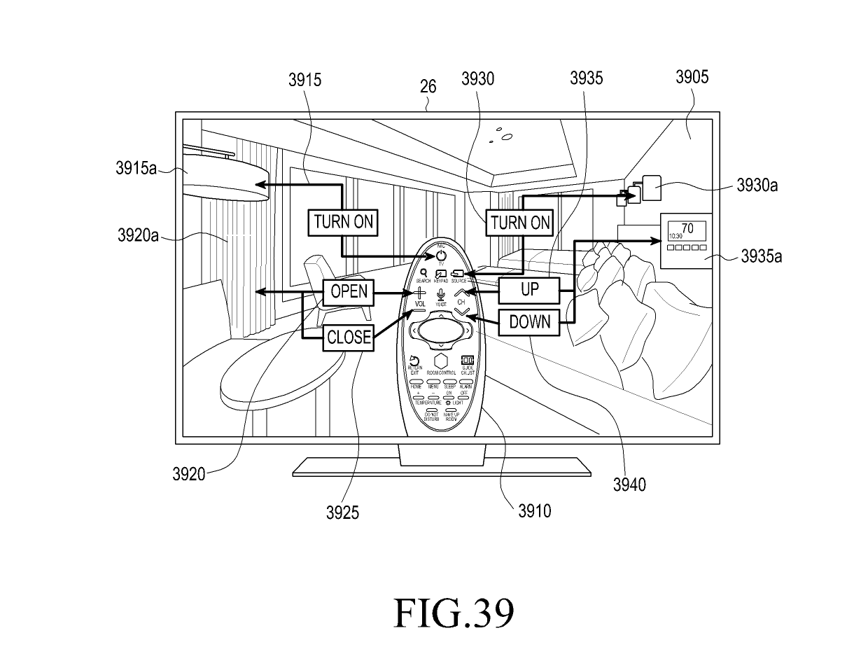

FIG. 39 illustrates an example of displaying a hot key mapping guide using a room image according to an embodiment of the present disclosure.

Referring to FIG. 39, the hot key mapping guide 3910 may be configured with an image resembling a real-life input unit of the remote controller 30, the name of the function corresponding to each hot key symbol on the input unit, and lines connecting the hot keys with the functions. Specifically, the hot key on the input unit may be connected with the symbol or image object of its corresponding controlled device via a line. In the example illustrated, the TV display 26 outputs a room drawing or a real picture of the room as background 3905 and displays the hot key mapping guide 3910 overlaid on the background 3905.

As an example, the hot key mapping guide 3910 includes the symbols of the volume-up key and volume-down key of the remote controller 30, and the symbols of the volume-up key and the volume-down key are connected through a line with at least one of the text boxes 3920 and 3925 of the names, [OPEN] and [CLOSE], of the corresponding functions and the symbol/image 3920a indicating the curtain in the background 3905.

As an example, the hot key mapping guide 3910 includes the symbols of the TV key of the remote controller 30 and the external input (SOURCE) key, and the symbols of the TV key and the external input key each are connected through a line with at least one of the text boxes 3915 and 3930 of the command names, [TURN ON] and [TURN OFF], of the corresponding functions and the symbols/images 3915a and 3930a indicating the stand light and mood light in the background 3905.

As an example, the hot key mapping guide 3910 includes the symbols of the previous channel key and next channel key of the remote controller 30, and the symbols of the previous channel key and next channel key are connected through a line with at least one of the text boxes 3935 and 3940 of the names, [UP] and [DOWN], of the corresponding functions and the symbol/image 3935a indicating the thermostat in the background 3905.

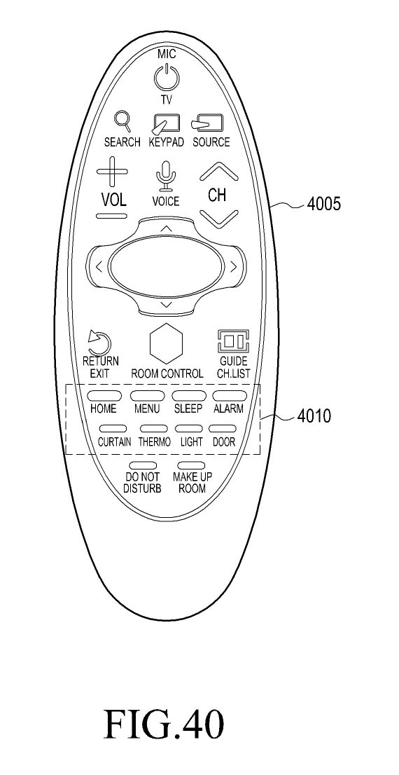

FIG. 40 illustrates an input unit of a remote controller including hot keys corresponding to controlled devices according to an embodiment of the present disclosure.

Referring to FIG. 40, an input unit 4010 of a remote controller 4005 may include at least one of, e.g., [CURTAIN], [THERMO], [LIGHT], and [DOOR], as hot keys corresponding to controlled devices. When the user enters the hot key of a device he desires to control, a hot key mapping guide for control of the function of the device may be output through the TV display 26 or the display (not shown) of the remote controller 4005. As an example, the hot key mapping guide corresponding to the hot key of [CURTAIN] may include menu items, [OPEN CURTAIN] and [CLOSE CURTAIN]. As an example, the hot key mapping guide corresponding to the hot key of [THERMO] may include menu items, [TEMPERATURE UP] and [TEMPERATURE DOWN]. As an example, the hot key mapping guide corresponding to the hot key of [LIGHT] may include menu items, [LIGHT ON] and [LIGHT OFF]. As an example, the hot key mapping guide corresponding to the hot key of [DOOR] may include menu items, [OPEN] and [CLOSE].

In an embodiment, each hot key mapping guide may further include or may be replaced with a guide notification of a motion input corresponding to the menu items. As an example the hot key mapping guide corresponding to the hot key of [CURTAIN] may further include a guidance text [MOTION: UP (↑)] for [OPEN CURTAIN] and a guidance text [MOTION: DOWN (↓)] for [CLOSE CURTAIN]. As an example the hot key mapping guide corresponding to the hot key of [THERMO] may further include a guidance text [MOTION: LEFT (←)] for [VOLUME UP] and a guidance text [MOTION: RIGHT (→)] for [VOLUME DOWN].

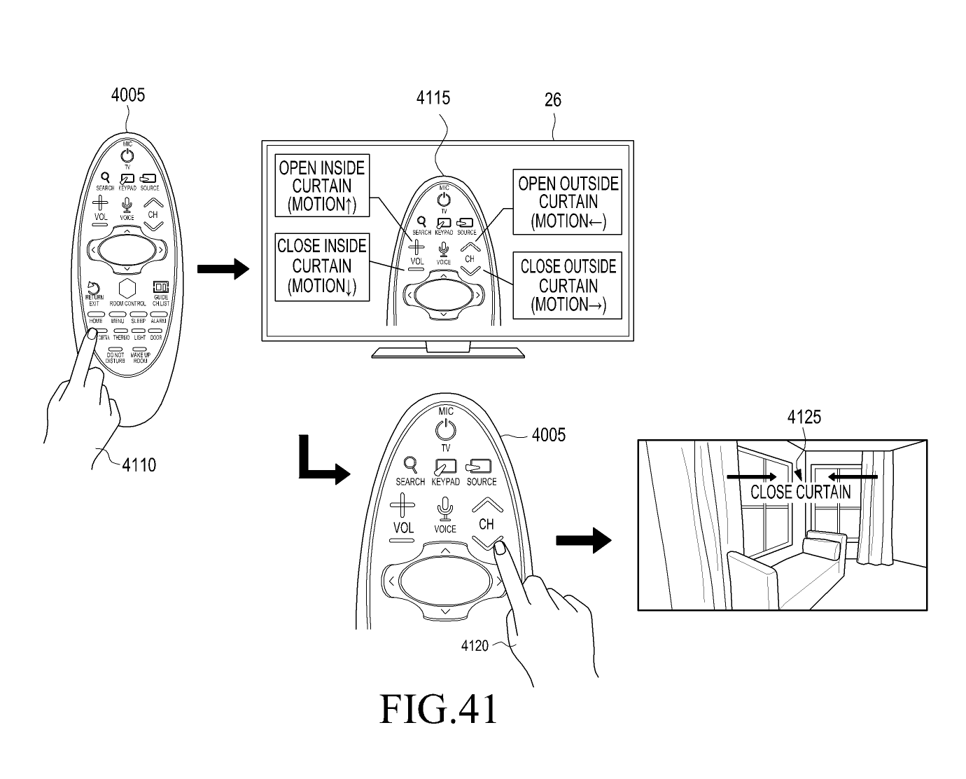

FIG. 41 is a view illustrating a control operation by a curtain using a hot key of a remote controller according to an embodiment of the present disclosure.

Referring to FIG. 41, when detecting an input 4110 for the hot key of [CURTAIN] of the remote controller 4005, the remote controller 4005 transmits a key input signal corresponding to the input 4110 to the gateway 22. The gateway 22 displays a hot key mapping guide 4115 including menu items for controlling the curtain on the TV display 26 in response to the reception of the key input signal. The hot key mapping guide 4115 includes the menu items of [OPEN INSIDE CURTAIN] mapped to the volume-up key of the remote controller 4005 and [CLOSE INSIDE CURTAIN] mapped to the volume-down key and menu items of [OPEN OUTSIDE CURTAIN] mapped to the previous channel key and [CLOSE OUTSIDE CURTAIN] mapped to the next channel key.

When detecting an input 4120 for the next channel key of the remote controller 4005 while the hot key mapping guide 4115 is displayed, the gateway 22 transmits the control command to close to the outside curtain in response to the input 4120 so that the outside curtain closes (4125).

Additionally or optionally, the hot key mapping guide 4115 may further include a guidance text of a motion input for controlling each function of each device or may include replaced menu items. As an example, [OPEN INSIDE CURTAIN] is displayed (or replaced) with the guidance text of [MOTION: UP(↑)], and [CLOSE INSIDE CURTAIN] is displayed (or replaced) with the guidance text of [MOTION: DOWN(↓)]. When detecting that the remote controller 4005 moves upward while the hot key mapping guide 4115 is displayed, a control command of “Open” is transmitted to the inside curtain. Similarly, when detecting that the remote controller 4005 moves downward while the hot key mapping guide 4115 is displayed, a control command of “Close” is transmitted to the inside curtain.

As another example, [OPEN OUTSIDE CURTAIN] is displayed (or replaced) with the guidance text of [MOTION: LEFT(←)], and [CLOSE OUTSIDE CURTAIN] is displayed (or replaced) with the guidance text of [MOTION: RIGHT(→)]. When detecting that the remote controller 4005 moves left while the hot key mapping guide 4115 is displayed, a control command of “Open” is transmitted to the outside curtain. Similarly, when detecting that the remote controller 4005 moves right while the hot key mapping guide 4115 is displayed, a control command of “Close” is transmitted to the outside curtain.

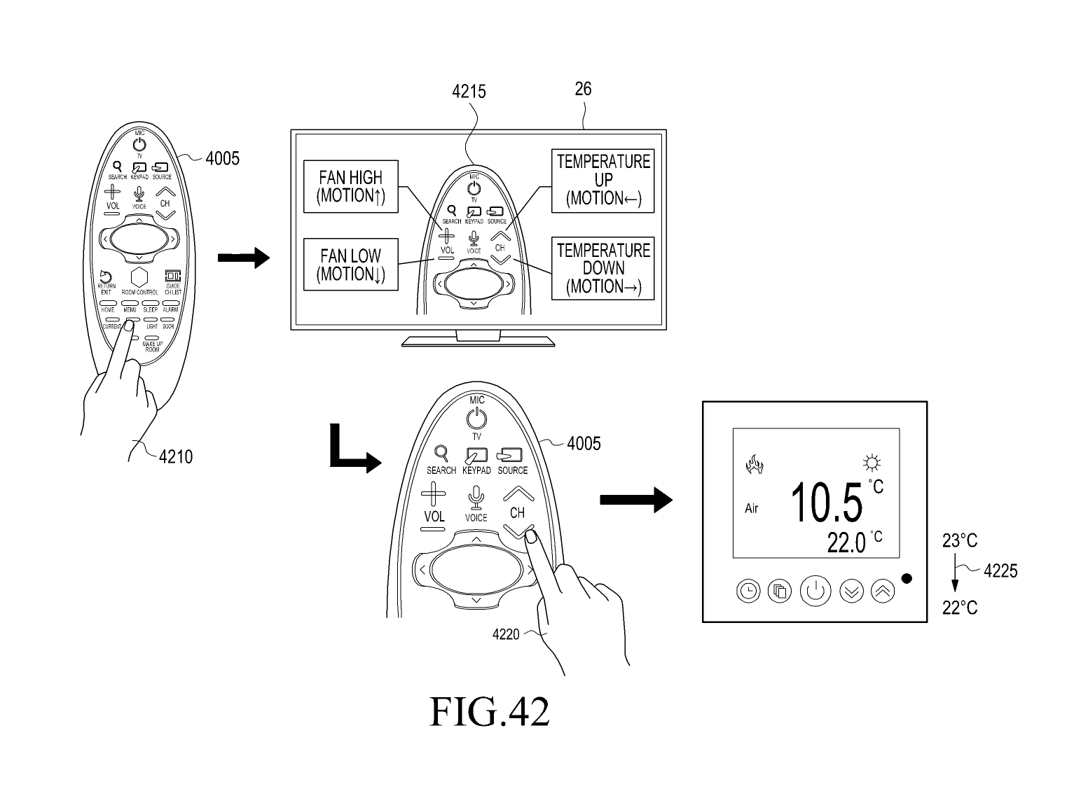

FIG. 42 is a view illustrating a control operation by a thermostat using a hot key of a remote controller according to an embodiment of the present disclosure.

Referring to FIG. 42, when detecting an input 4210 for the hot key of [THERMO] of the remote controller 4005, the remote controller 4005 transmits a key input signal corresponding to the input 4210 to the gateway 22. The gateway 22 displays a hot key mapping guide 4215 including menu items for controlling the thermostat on the TV display 26 in response to the reception of the key input signal. The hot key mapping guide 4215 includes the menu items of [FAN HIGH] mapped to the volume-up key of the remote controller 4005 and [FAN LOW] mapped to the volume-down key and menu items of [TEMPERATURE UP] mapped to the previous channel key and [TEMPERATURE DOWN] mapped to the next channel key.

When detecting an input 4220 for the next channel key of the remote controller 4005 while the hot key mapping guide 4215 is displayed, the gateway 22 transmits the control command of temperature down to the thermostat in response to the input 4220 so that the thermostat lowers the set temperature from the currently set temperature 24° C. to 22° C. (4225).

Additionally or optionally, the hot key mapping guide 4215 may further include a guidance text of a motion input for controlling each function of each device or may include replaced menu items. As an example, [FAN HIGH] is displayed (or replaced) with the guidance text of [MOTION: UP(↑)], and [FAN LOW] is displayed (or replaced) with the guidance text of [MOTION: DOWN(↓)]. When detecting that the remote controller 4005 moves upward while the hot key mapping guide 4215 is displayed, a control command of “speed up” is transmitted to the fan (FAN) Similarly, when detecting that the remote controller 4005 moves downward while the hot key mapping guide 4215 is displayed, a control command of “speed down” is transmitted to the fan.

As another example, [TEMPERATURE UP] is displayed (or replaced) with the guidance text of [MOTION: LEFT(←)], and [TEMPERATURE DOWN] is displayed (or replaced) with the guidance text of [MOTION: RIGHT(→)]. When detecting that the remote controller 4005 moves left while the hot key mapping guide 4215 is displayed, a control command of “temperature up” is transmitted to the thermostat. Similarly, when detecting that the remote controller 4005 moves right while the hot key mapping guide 4215 is displayed, a control command of “temperature down” is transmitted to the thermostat.

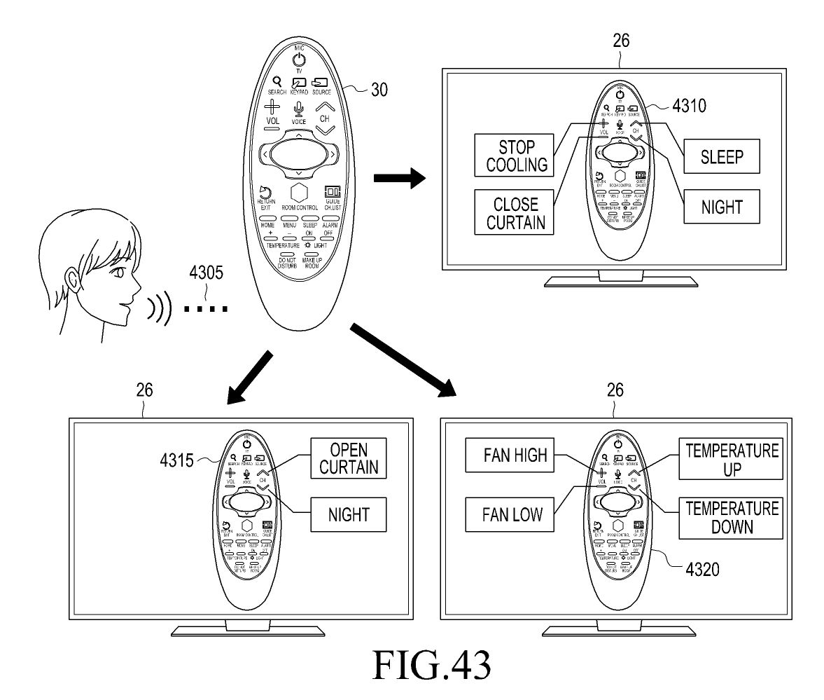

FIG. 43 is a view illustrating a device control and user state input operation using a voice command according to an embodiment of the present disclosure.

Referring to FIG. 43, when a user's voice command 4305 is input to the remote controller 30, the remote controller 30 transfers the voice command 4305 to the gateway 22. The gateway 22 analyzes the voice command 4305 and outputs hot key mapping guides 4310, 4315, and 4320 including a control menu corresponding to the voice command 4305 to the TV display 26. As an example, the voice command 4305 may include at least one of “Open the curtain,” “Close the curtain,” “Hot,” “Cold,” “Temperature down,” “Wanna sleep,” “Dark,” “Light on,” “Open the door,” and “Lock the door.”

As an example, when the voice command 4305 is “Open the curtain” or “Close the curtain,” the hot key mapping guide 4315 displayed on the TV display 26 may include the menu items [OPEN CURTAIN] and [CLOSE CURTAIN].

As an example, when the voice command 4305 is “Wanna sleep,” the hot key mapping guide 4310 displayed on the TV display 26 may include the menu items for device control, [STOP COOLING] and [CLOSE CURTAIN], and the menu items for service request, [SLEEP] and [NIGHT].

As an example, when the voice command 4305 is related to adjusting temperature, such as “Temperature up,” “Temperature down,” “Hot,” and “Cold,” the hot key mapping guide 4320 displayed on the TV display 26 may include the menu items [FAN HIGH], [FAN LOW], [TEMPERATURE UP], and [TEMPERATURE DOWN].

Additionally or optionally, each hot key mapping guide 4310, 4315, and 4320 may further include a guidance text of a motion input corresponding to the control menus. As an example, the control menus of the hot key mapping guide 4310, [Stop cooling], [CLOSE CURTAIN], [SLEEP], and [NIGHT], may be respectively displayed together with guidance texts [MOTION: UP(↑)], [MOTION: DOWN(↓)], [MOTION: LEFT(←)], and [TEMPERATURE DOWN].

Various embodiments of the present disclosure may be implemented in computer-readable codes on a computer-readable recording medium in particular points of view. The computer readable recording medium is a data storage device that may store data readable by a computer system. Examples of the computer readable recording medium may include read only memories (ROMs), random access memories (RAMs), compact disc-ROMs (CD-ROMs), magnetic tapes, floppy disks, optical data storage devices, and carrier waves (such as data transmission over the Internet). The computer readable recording medium may be distributed by computer systems over a network, and accordingly, the computer readable codes may be stored and executed in a distributed manner Functional programs, codes, and code segments to attain various embodiments of the present disclosure may be readily interpreted by skilled programmers in the art to which the present disclosure pertains.

The apparatuses and methods according to various embodiments of the present disclosure may be implemented in hardware, software, or a combination of hardware and software. Such software may be recorded in volatile or non-volatile storage devices, such as ROMs, memories, such as RAMs, memory chips, memory devices, or integrated circuit devices, CDs, digital video discs (DVDs), magnetic disks, magnetic tapes, or other optical or magnetic storage devices while retained in machine (e.g., computer)-readable storage media. The methods according to various embodiments of the present disclosure may be implemented by a computer or a portable terminal including a controller and a memory, and the memory may be a machine-readable storage medium that may properly retain program(s) containing instructions for implementing the various embodiments of the present disclosure.

Accordingly, the present disclosure encompasses a program containing codes for implementing the device or method set forth in the claims of this disclosure and a machine (e.g., computer)-readable storage medium storing the program. The program may be electronically transferred via any media such as communication signals transmitted through a wired or wireless connection and the present disclosure properly includes the equivalents thereof.

The apparatuses according to various embodiments of the present disclosure may receive the program from a program providing device wiredly or wirelessly connected thereto and store the same. The program providing apparatus may include a memory for storing a program including instructions enabling a program processing apparatus to perform a method according to an embodiment of the present disclosure and data necessary for a method according to an embodiment of the present disclosure, a communication unit for performing wired or wireless communication with a graphic processing apparatus, and a controller transmitting the program to the graphic processing apparatus automatically or as requested by the graphic processing apparatus.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for a service-oriented input and output, the method comprising:
determining orientation information regarding a remote controller in response to a first user input detected by the remote controller;
selecting a device based on location information regarding devices included in a previously stored controlled target list and the determined orientation information;
outputting a control menu including at least one control item for the selected device;
detecting a second user input corresponding to the output control menu; and
transmitting a control command indicating a control item corresponding to the second user input to the selected device.

2. The method of claim 1, wherein the selecting of the device based on the location information comprises selecting the at least one device based on at least one of relative location information regarding a device included in the controlled target list when there are a plurality of devices corresponding to the orientation information, and a motion input corresponding to one of a plurality of devices displayed according to the orientation information.

3. The method of claim 1, wherein the first user input comprises an input for one of a hot key guide key included in an input unit of the remote controller, a device selection key for selecting a controlled device, and a plurality of device keys corresponding to controlled devices, and/or
wherein the second user input includes at least one of a key input, a motion input, a touch input, and a voice input guided by the control menu.

4. The method of claim 1, wherein the control menu comprises at least one of menu items indicating functions that may be performed by the selected device and corresponding to at least some keys of the remote controller and a guidance text indicating an input scheme of each control item, and
wherein the control menu is configured considering at least one of a time zone, a season, a guest profile, and a room mode.

5. The method of claim 1, wherein the control menu comprises symbols indicating at least some keys among keys of the remote controller, menu items indicating functions that may be performed by the selected device, and mapping information associating the at least some keys with the menu items.

6. The method of claim 1, further comprising:
displaying a control menu adaptively configured depending on devices arranged in a room and a state of the room in response to the first user input,
wherein the control menu comprises symbols indicating at least some keys among keys of the remote controller, menu items indicating functions that may be performed by at least one device arranged in the room, and mapping information associating the at least some keys with the menu items.

7. A method for a service-oriented input and output, the method comprising:
receiving a first user input signal corresponding to a first user input detected by a remote controller and including orientation information regarding the remote controller;
selecting a device based on location information regarding devices included in a previously stored controlled target list and the orientation information;
transmitting information regarding a control menu including at least one control item for the selected device to a television (TV) display;
receiving a second user input signal corresponding to a second user input detected by the remote controller while the control menu is displayed by the TV display; and
transmitting a control command indicating a control item corresponding to the second user input to the selected device.

8. The method of claim 7, wherein the selecting of the device based on the location information comprises selecting the at least one device based on at least one of relative location information regarding a device included in the controlled target list when there are a plurality of devices corresponding to the orientation information, and a motion input corresponding to one of a plurality of devices displayed according to the orientation information.

9. The method of claim 7, wherein the first user input comprises an input for one of a hot key guide key included in an input unit of the remote controller, a device selection key for selecting a controlled device, and a plurality of device keys corresponding to controlled devices, and/or
wherein the second user input comprises at least one of a key input, a motion input, a touch input, and a voice input guided by the control menu.

10. The method of claim 7, wherein the control menu comprises at least one of menu items indicating functions that may be performed by the selected device and corresponding to at least some keys of the remote controller and a guidance text indicating an input scheme of each control item, and
wherein the control menu is configured considering at least one of a time zone, a season, a guest profile, and a room mode.

11. The method of claim 7, wherein the control menu comprises symbols indicating at least some keys among keys of the remote controller, menu items indicating functions that may be performed by the selected device, and mapping information associating the at least some keys with the menu items.

12. The method of claim 7, further comprising:
transmitting information regarding a control menu adaptively configured depending on devices arranged in a room and a state of the room in response to the first user input to the TV display,
wherein the control menu comprises symbols indicating at least some keys among keys of the remote controller, menu items indicating functions that may be performed by at least one device arranged in the room, and mapping information associating the at least some keys with the menu items.

13. An apparatus for providing a service-oriented input and output, the apparatus comprising:
an input unit configured to detect a user input;
an output unit including a display;
a controller configured to:
determine orientation information in response to a first user input detected by the input unit,
select a device based on location information regarding devices included in a previously stored controlled target list and the determined orientation information,
generate a control menu including at least one control item for the selected device,
output the control menu through the display, and
generate a control command indicating a control item corresponding to a second user input when the second user input is detected by the input unit while the control menu is displayed; and
a communication unit configured to transmit the control command to the selected device.

14. An apparatus for providing a service-oriented input and output, the apparatus comprising:
a first communication unit configured to communicate with a remote controller;
a second communication unit configured to communicate with a plurality of devices; and
a controller configured to:
select a device based on location information regarding devices included in a previously stored controlled target list and orientation information regarding the connection request when a first user input signal corresponding to a first user input detected by the remote controller and including the orientation information is received by the first communication unit,
output information regarding a control menu including at least one control item for the selected device through a television (TV) display, and
transmit a control command indicating a control item corresponding to a second user input detected by the remote controller to the selected device through the second communication unit when a second user input signal corresponding to the second user input is received by the first communication unit while the control menu is displayed through the TV display.

15. A method for a service-oriented input and output, the method comprising:
receiving a hot key input from a remote controller;
transmitting a command corresponding to the hot key input to a device corresponding to the command;
receiving a processing result according to the command from the device;
when a display is inactivated upon reception of the processing result, activating the display and outputting a message according to the processing result through the display; and
inactivating the display after the output of the message is ended.

16. The method of claim 15, wherein the hot key input comprises at least one of a temperature-up key, a temperature-down key, a light-on key, a light-off key, a do-not-disturb key to request a do-not-disturb service, and a request-housekeeping key to request a housekeeping service.

17. The method of claim 15, wherein, when the display is inactivated upon reception of the hot key input, transmission of the command and reception of the processing result are processed while the display remains inactivated.

18. The method of claim 15, wherein the command indicates device control for at least one device relating to a hotel room or a service request to a hotel manager, and/or
wherein the message comprises at least one of a current temperature and a set temperature according to a temperature control request, a per-zone illumination state according to an illumination control request, and an admission state for a requested service.

19. The method of claim 15, further comprising:
when the hot key input relates to an illumination control request, activating the display in response to reception of the hot key input and outputting a layout including a plurality of zones in a room through the display;
highlighting at least one zone on the layout; and
changing the highlighted zone on the layout in response to reception of an additional hot key input through the remote controller.

20. A method for a service-oriented input and output, the method comprising:
receiving a command corresponding to a hot key input detected by a remote controller;
determining whether the command relates to a device control or a service request;
determining at least one controlled device when the command relates to the device control and transmitting a control command corresponding to the command to the determined at least one device;
receiving a state changed result from the at least one device and outputting the state changed result through a television (TV) display;
transmitting a service identifier (ID) corresponding to the command to a server when the command relates to the service request; and
receiving a processing result of the service request from the server and outputting the processing result through the TV display.

21. An apparatus for providing a service-oriented input and output, the apparatus comprising:
a first communication unit configured to receive a hot key input from a remote controller;
a second communication unit configured to:
transmit a command corresponding to the hot key input to a device corresponding to the command, and
receive a processing result according to the command from the device; and
a controller configured to:
activate a television (TV) display when the TV display is inactivated upon reception of the processing result,
output a message according to the processing result through the TV display, and
inactivate the TV display after the output of the message is ended.

22. An apparatus for providing a service-oriented input and output, the apparatus comprising:
a first communication unit configured to receive a command corresponding to a hot key input detected by a remote controller;
a second communication unit configured to communicate with a server; and
a controller configured to:
determine whether the command relates to a device control or a service request,
determine at least one controlled device when the command relates to the device control,
transmit a control command corresponding to the command to the determined at least one device,
receive a state changed result from the at least one device,
transmit the state changed result to a television (TV) display,
transmit a service identifier (ID) corresponding to the command to a server through the second communication unit when the command relates to the service request,
receive a processing result of the service request from the server through the second communication unit, and
transmit the processing result to the TV display.
